(19) United States
(12) Patent Application Publication
(10) Pub. No.: US 2020/0020933 A1
(43) Pub. Date: Jan. 16, 2020

(54) NEGATIVE ELECTRODE ACTIVE MATERIAL, NEGATIVE ELECTRODE, BATTERY, BATTERY PACK, ELECTRONIC DEVICE, ELECTRIC VEHICLE, POWER STORAGE DEVICE AND POWER SYSTEM

(71) Applicant: MURATA MANUFACTURING CO., LTD., Kyoto (JP)

(72) Inventors: Daisuke ITO, Kyoto (JP); Susumu SATO, Kyoto (JP); Kenji KATORI, Kyoto (JP)

(21) Appl. No.: 16/448,354

(22) Filed: Jun. 21, 2019

Related U.S. Application Data
(63) Continuation of application No. PCT/JP2017/041201, filed on Nov. 16, 2017.

(30) Foreign Application Priority Data
Dec. 29, 2016 (JP) 2016-257376

(51) Int. Cl. H01M 4/36; H01M 4/38; H01M 10/0567; H01M 10/0525

(52) U.S. Cl. CPC H01M 4/366; H01M 4/386; H01M 2004/027; H01M 10/0567; H01M 10/0525; H01M 4/387

(57) ABSTRACT

The negative electrode active material has a core portion containing at least one of silicon, tin, or germanium and a covering portion covering at least a part of a surface of the core portion and the covering portion contains a phosphoric acid-containing compound.

### TECHNICAL FIELD

The present art relates to a negative electrode active material, a negative electrode, a battery, a battery pack, an electronic device, an electrically driven vehicle, a power storage apparatus, and a power system.

### BACKGROUND ART

In recent years, demands for high capacity, high cycle characteristics, and high load characteristics of batteries have increased, and various materials for active material have been developed. However, in the batteries, the most important thing is the reactivity with the electrolytic solution, and the deposition of solid electrolyte interface (SEI) causes various adverse effects such as loss of conductivity, loss of ion conductivity, depletion of electrolytic solution, and gas generation.

Patent Document 1 proposes an art for covering at least a part of the surface of lithium titanium composite oxide particles with at least one element selected from the group consisting of phosphorus and sulfur or a compound of this element in order to suppress gas generation.

### PRIOR ART DOCUMENT

### Patent Document

Patent Document 1: Japanese Patent Application Laid-Open No. 2010-27377

### SUMMARY OF THE INVENTION

### Problem to be Solved by the Invention

In recent years, development of Si-based materials as a negative electrode material having a higher capacity than carbon-based materials has been intensively advanced. There is a tendency that particularly SEI is likely to be deposited on the Si-based materials, and it can be thus said that it is an important factor to suppress electrolytic solution reaction for the maintenance of battery performance. However, with regard to the covering of Si-based materials, there are a number of approaches emphasizing the maintenance of conductivity such as carbon covering and metal covering but there are few approaches focused on the surface reactivity. Patent Document 1 above also does not describe the surface covering of Si-based materials.

Moreover, in the case of suppressing the surface reaction by artificial SEI formation, such as fluoroethylene carbonate (FEC), suppression of the surface reaction is based on the decomposition of FEC in the first place, and thus side effects such as gas generation due to FEC decomposition and FEC depletion during cycling are inevitable.

An object of the present art is to provide a negative electrode active material with which the cycle characteristics can be ameliorated, a negative electrode, a battery, and a battery pack, an electronic device, an electrically driven vehicle, a power storage apparatus, and a power system which include the battery.

### Means for Solving the Problem

In order to solve the above-described problem, a first art is a negative electrode active material having a core portion containing at least one of silicon, tin, or germanium and a covering portion covering at least a part of a surface of the core portion, in which the covering portion contains a phosphoric acid-containing compound.

A second art is a negative electrode containing the negative electrode active material of the first art.

A third art is a battery including a negative electrode containing the negative electrode active material of the first art, a positive electrode, and an electrolyte.

A fourth art is a battery pack including the battery of the third art and a control unit configured to control the battery.

A fifth art is an electronic device which includes the battery of the third art and receives power supply from the battery.

A sixth art is an electrically driven vehicle including the battery of the third art, a converter configured to receive power supply from the battery and convert the power into a driving force of the vehicle, and a controller configured to perform information processing on vehicle control based on information on the battery.

A seventh art is a power storage apparatus which includes the battery of the third art and supplies power to an electronic device connected to the battery.

An eighth art is a power system which includes the battery of the third art and receives power supply from the battery.

### Advantageous Effect of the Invention

According to the present art, it is possible to ameliorate the cycle characteristics of battery. Incidentally, the effects described herein are not necessarily limited and may be any of the effects described in the present disclosure or effects different from these.

### BRIEF EXPLANATION OF DRAWINGS

FIG. 1 is a cross-sectional diagram illustrating an example of the configuration of a negative electrode active material according to a first embodiment of the present art.

FIG. 2 is a schematic diagram illustrating an example of the configuration of a sputtering apparatus for forming a covering portion.

FIGS. 3A and 3B are cross-sectional diagrams each illustrating an example of the configuration of a negative electrode active material according to Modification 2 of a first embodiment of the present art.

FIG. 4 is a cross-sectional diagram illustrating an example of the configuration of a non-aqueous electrolyte secondary battery according to a second embodiment of the present art.

FIG. 5 is an enlarged cross-sectional diagram illustrating a part of the wound electrode assembly illustrated in FIG. 4.

FIG. 6 is an exploded perspective diagram illustrating an example of the configuration of a non-aqueous electrolyte secondary battery according to a third embodiment of the present art.

FIG. 7 is a cross-sectional diagram of a wound electrode assembly taken along the line VII-VII in FIG. 6.

FIGS. 8A, 8B, and 8C are graphs illustrating the results on the XPS depth analysis of Li₃PO₄-covered SiOₓ particles, respectively.

FIG. 9 is a graph illustrating the results on the XPS valence analysis of Li₃PO₄-covered SiOₓ particles, SiOₓ particles, and heat-treated SiOₓ particles.

FIG. 10 is a block diagram illustrating an example of the configuration of an electronic device as an application example.

FIG. 11 is a schematic diagram illustrating an example of the configuration of a power storage system in a vehicle as an application example.

FIG. 12 is a schematic diagram illustrating an example of the configuration of a power storage system in a house as an application example.

### MODE FOR CARRYING OUT THE INVENTION

Embodiments of the present are will be described in the following order.

1 First embodiment (example of negative electrode active material)
2 Second embodiment (example of cylindrical battery)
3 Third Embodiment (example of laminated film type battery)
4 Application Example 1 (battery pack and electronic device)
5 Application Example 2 (power storage system in vehicle)
6 Application Example 3 (power storage system in house)

### 1 First Embodiment

### [Configuration of Negative Electrode Active Material]

### (Negative Electrode Active Material Particles)

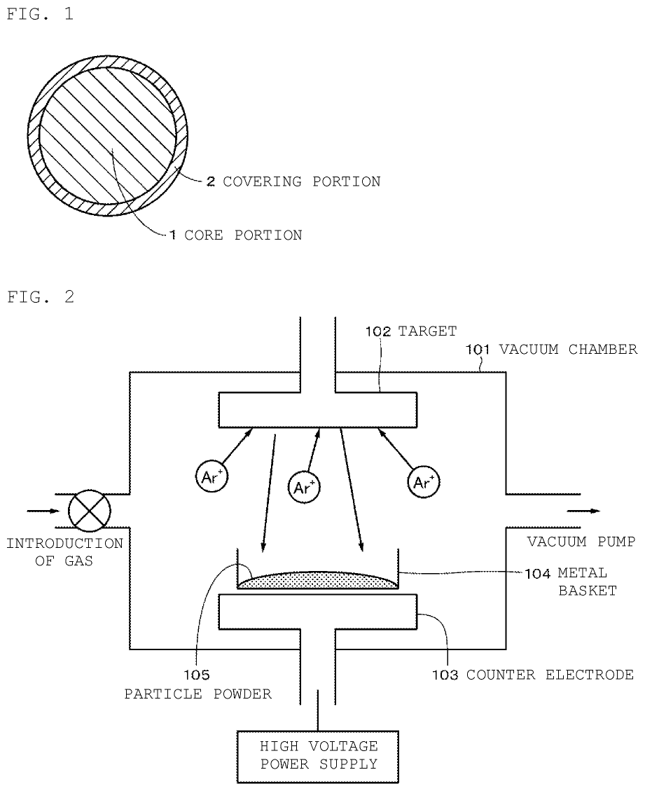

The negative electrode active material according to the first embodiment of the present art contains a powder of negative electrode active material particles. This negative electrode active material is, for example, for non-aqueous electrolyte secondary batteries such as lithium ion secondary batteries. This negative electrode active material may be used in a LiSi—S battery or a LiSi—Li₂S battery. As illustrated in FIG. 1, the negative electrode active material particle has a core portion 1 and a covering portion 2 covering at least a part of the surface of the core portion 1, and the covering portion 2 contains a compound containing phosphoric acid (PₓO_{y}) (hereinafter referred to as “phosphoric acid-containing compound”). The composition and state of both the core portion 1 and the covering portion 2 may be changed discontinuously or continuously.

### (Core Portion)

The core portion 1 has a particle shape and contains at least one of silicon, tin, or germanium. More specifically, the core portion 1 contains at least one of crystalline silicon, amorphous silicon, silicon oxide, a silicon alloy, crystalline tin, amorphous tin, tin oxide, a tin alloy, crystalline germanium, amorphous germanium, germanium oxide, or a germanium alloy.

Crystalline silicon, crystalline tin, and crystalline germanium are crystalline or in mixture of crystalline and amorphous. Here, crystalline includes not only single crystals but also polycrystals in which a great number of crystal grains are gathered. Crystalline refers to a state in which a substance is a crystallographically single crystal or polycrystal so that a peak is observed in X-ray diffraction and electron beam diffraction. Amorphous refers to a state in which a substance is crystallographically amorphous so that a halo is observed in X-ray diffraction or electron beam diffraction. Mixture of amorphous and crystalline refers to a state in which the crystallographically amorphous state and the crystallographically crystalline state are present together so that a peak and a halo are observed in X-ray diffraction and electron beam diffraction.

Silicon oxide is, for example, SiOₓ (0.33<x<2). Tin oxide is, for example, SnO_{y} (0.33<y<2). Germanium oxide is, for example, SnO_{y} (0.33<y<2). Examples of silicon alloys include those that contain at least one selected from the group consisting of tin, nickel, copper, iron, cobalt, manganese, zinc, indium, silver, titanium, germanium, bismuth, antimony, and chromium as a second constituent element other than silicon. Examples of tin alloys include those that contain at least one selected from the group consisting of silicon, nickel, copper, iron, cobalt, manganese, zinc, indium, silver, titanium, germanium, bismuth, antimony, and chromium as a second constituent element other than tin. Examples of germanium alloys include those that contain at least one selected from the group consisting of silicon, tin, nickel, copper, iron, cobalt, manganese, zinc, indium, silver, titanium, bismuth, antimony, and chromium as a second constituent element other than germanium.

The core portion 1 may be primary particles or secondary particles in which a plurality of primary particles are aggregated. The core portion 1 has, for example, a particulate shape, a layered shape, or a three-dimensional shape. Examples of the shape of the particles include a spherical shape, an ellipsoidal shape, a needle shape, a plate shape, a scale shape, a tubular shape, a wire shape, a pole shape (rod shape), or an irregular shape but are not particularly limited thereto. Incidentally, particles in two or more kinds of shapes may be used in combination. Here, the spherical shape includes not only a perfect spherical shape but also a shape in which a perfect spherical shape is slightly flattened or distorted, a shape in which concave and convex are formed on the surface of a perfect spherical shape, or a shape in which these shapes are combined. The ellipsoidal shape includes not only a strictly ellipsoidal shape but also a shape in which a strictly ellipsoidal shape is slightly flattened or distorted, a shape in which concave and convex are formed on the surface of a strictly ellipsoidal shape, or a shape in which these shapes are combined.

### (Covering Portion)

The covering portion 2 may partially cover the surface of the core portion 1 or may cover the entire surface of the core portion 1, but it is preferable to cover the entire surface of the core portion 1 from the viewpoint of improving the cycle characteristics. The shape of the covering portion 2 includes an island shape or a thin film shape but is not particularly limited to these shapes. The thin film-shaped covering portion 2 may have one or two or more hole portions. The average thickness of the covering portion 2 is preferably 10 nm or less, more preferably 8 nm or less, and still more preferably 3 nm or more and 5 nm or less.

The phosphoric acid-containing compound contains, for example, P, at least one of Li, Mg, Al, B, Na, K, Ca, Mn, Fe, Co, Ni, Cu, Ag, Zn, Ga, In, Pb, Mo, W, Zr, or Hf, and at least one of a group 15 element, a group 16 element, or a group 17 element. The phosphoric acid-containing compound may contain, for example, P, at least one of Mg, Al, B, Na, K, Ca, Mn, Fe, Co, Ni, Cu, Ag, Zn, Ga, In, Pb, Mo, W, Zr, or Hf, and at least one of a group 15 element, a group 16 element, or a group 17 element. The group 15, 16, and 17 elements are, for example, at least one of N, F, S, Cl, As, Se, Br, or I.

The phosphoric acid-containing compound is represented by the following Formula (1).

M_{z}PₓO_{y}:XX (1)

(Provided that M represents at least one of metal elements and XX represents at least one of a group 15 element, a group 16 element, or a group 17 element. z is 0.1≤z≤3, x is 0.5≤x≤2, and y is 1≤y≤5.)

Here, the notation “M_{z}PₓO_{y}:XX” in Formula (1) above means a state in which XX is contained in M_{z}PₓO_{y}, and XX may form a bond with M_{z}PₓO_{y} or may not form a bond.

M is, for example, at least one of Li, Mg, Al, B, Na, K, Ca, Mn, Fe, Co, Ni, Cu, Ag, Zn, Ga, In, Pb, Mo, W, Zr, or Hf. M may be, for example, at least one of Mg, Al, B, Na, K, Ca, Mn, Fe, Co, Ni, Cu, Ag, Zn, Ga, In, Pb, Mo, W, Zr, or Hf. XX is, for example, at least one of N, F, S, Cl, As, Se, Br, or I.

### [Sputtering Apparatus]

FIG. 2 is a schematic diagram illustrating an example of the configuration of a sputtering apparatus for forming the covering portion 2. This sputtering apparatus is so-called RF (radio frequency) magnetron sputtering and includes a vacuum chamber 101 and a target 102 and a counter electrode 103 which are provided in the vacuum chamber 101. The target 102 is a Li₃PO₄ sintered body target. The counter electrode 103 is held so as to face the target 102. In addition, the counter electrode 103 has a metal basket 104 on the surface facing the target 102, and a particle powder 105 is supplied to this metal basket 104. The counter electrode 103 is provided with a vibrator, and the sputtering apparatus is configured to be capable of performing sputtering while moving the particle powder 105 by the vibrator. The vacuum chamber 101 is connected to a vacuum evacuating unit (not illustrated) for evacuating the interior of the vacuum chamber 101 and a gas supply unit (not illustrated) for supplying a process gas into the vacuum chamber 101.

### [Method for Manufacturing Negative Electrode Active Material]

Hereinafter, an example of the method for manufacturing the negative electrode active material according to the first embodiment of the present art will be described.

First, after the particle powder 105 is supplied to the metal basket 104, the vacuum chamber 101 is vacuum-pumped until to have a predetermined pressure. Here, the particle powder 105 is a powder of the core portion 1. Thereafter, the target 102 is sputtered to cover the surface of the particle powder 105 with Li₃PO₄ while introducing a process gas such as Ar gas into the vacuum chamber 101. At this time, the surface of the particle powder 105 can be more uniformly covered with Li₃PO₄ by moving the particle powder 105 using a vibrator.

### [Effect]

The negative electrode active material according to the first embodiment has the core portion 1 containing at least one of silicon, tin, or germanium and the covering portion 2 covering at least a part of the surface of the core portion 1 and in which the covering portion 2 contains a phosphoric acid-containing compound. This makes it possible to suppress the electrolyte decomposition (Li consumption) on the surface of the negative electrode active material particles. Consequently, it is possible to ameliorate the cycle characteristics of battery.

In addition, it is also possible to maintain the load characteristics (load characteristics after repeated cycles) by a decrease in gas expansion of a laminated film type battery and the like and a decrease in cell resistance. In addition, the phosphoric acid-containing compound exhibits favorable compatibility with a solid electrolyte and thus can also be applied to an all-solid-state battery. In this case, it is possible to decrease the negative electrode interface resistance of the all-solid-state battery (that is, to ameliorate the load characteristics).

### [Modification]

### (Modification 1)

The covering portion 2 may further contain at least one of carbon, a hydroxide, an oxide, a carbide, a nitride, a fluoride, a hydrocarbon molecule, or a polymer compound. The content of the at least one is preferably 0.05 mass % or more and 10 mass % and more preferably 0.1 mass % or more and 10 mass % or less. Here, “the content of the at least one” means the content of the at least one with respect to the entire negative electrode active material. The content of the at least one is determined by specifying the kind of materials contained in the surface of the negative electrode active material particles by X-ray photoelectron spectroscopy (XPS), infrared spectroscopy (IR), time-of-flight secondary ion mass spectrometry (TOF-SIMS) and the like, then dissolving the negative electrode active material particles in an acidic solution such as hydrochloric acid, and measuring the contents of the respective elements contained in the negative electrode active material particles by inductively coupled plasma atomic emission spectroscopy (ICP-AES).

### (Modification 2)

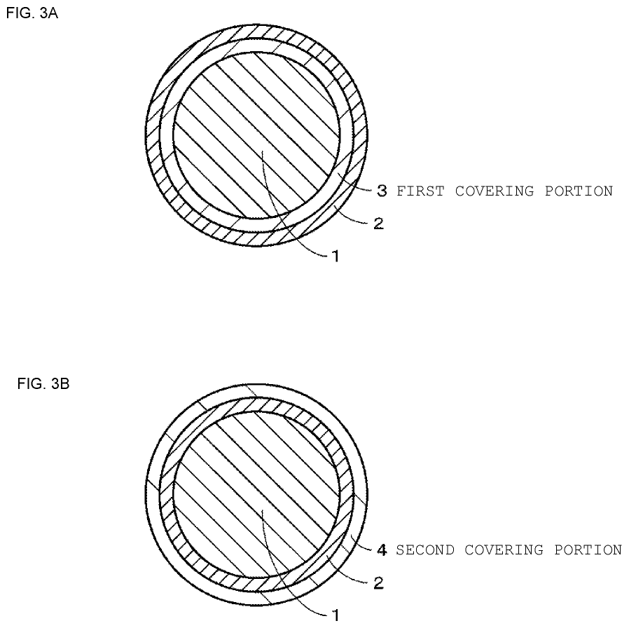

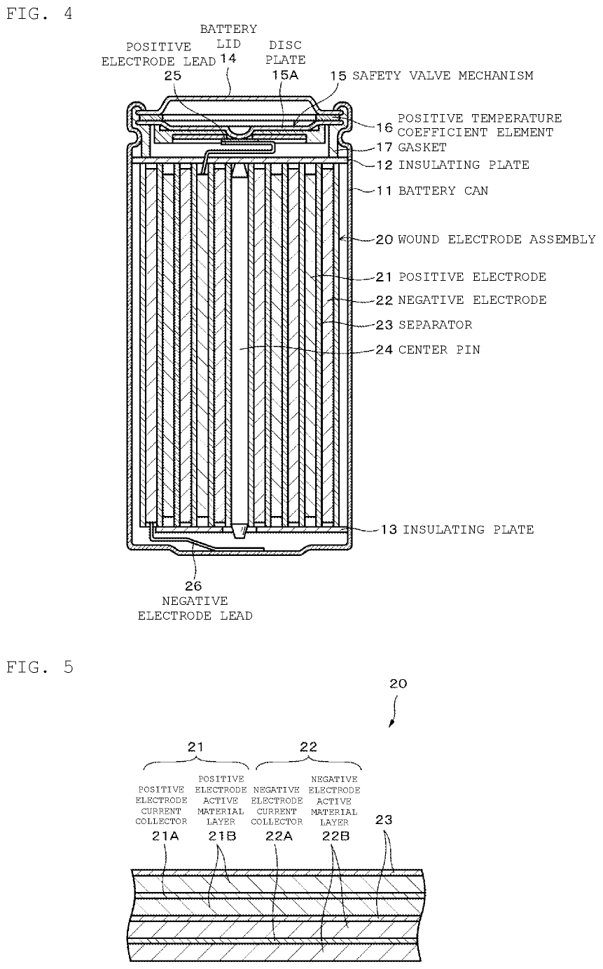

The negative electrode active material particles may further have a first covering portion 3 which is provided between the core portion 1 and the covering portion 2 and covers at least a part of the surface of the core portion 1 as illustrated in FIG. 3A, may further have a second covering portion 4 covering at least a part of the surface of the covering portion 2 as illustrated in FIG. 3B, or may have both the first covering portion and the second covering portion. The first covering portion and the second covering portion contain, for example, at least one of carbon, a hydroxide, an oxide, a carbide, a nitride, a fluoride, a hydrocarbon molecule, or a polymer compound. The content of the at least one is preferably 0.05 mass % or more and 10 mass % and more preferably 0.1 mass % or more and 10 mass % or less.

In addition, in a case in which the negative electrode active material particles have at least one of the first or second covering portion 3 or 4, the negative electrode active material particles may have two or more layers of covering portions 2. In this case, at least one of the first covering portion 3 or the second covering portion 4 is provided between the covering portions 2. In the case of providing two or more layers of covering portions 2, the kinds or composition ratios of the materials constituting these covering portions 2 may be different from each other.

### (Modification 3)

In the first embodiment, a case in which the core portion has a particulate shape has been described, but the core portion may have a layered or three-dimensional shape. The layered shape includes a thin film shape, a plate shape, or a sheet shape but it is not particularly limited thereto. Examples of the three-dimensional shape include a tubular shape such as a pole shape or a cylindrical shape, a shell shape such as a spherical shell shape, a curved shape, a polygonal shape, a three-dimensional mesh shape, or an irregular shape but are not particularly limited thereto. The core portion having a layered or three-dimensional shape may be a porous body.

### (Modification 4)

The negative electrode active material may be pre-doped with lithium. In this case, the core portion 1 contains lithium and at least one of silicon, tin, or germanium. More specifically, the core portion 1 contains at least one of lithium-containing crystalline silicon, lithium-containing amorphous silicon, lithium-containing silicon oxide, a lithium-containing silicon alloy, lithium-containing crystalline tin, lithium-containing amorphous tin, lithium-containing tin oxide, a lithium-containing tin alloy, lithium-containing crystalline germanium, lithium-containing amorphous germanium, lithium-containing germanium oxide, or a lithium-containing germanium alloy.

### (Modification 5)

In the first embodiment, an example of the method for manufacturing the negative electrode active material in which the covering portion is formed by the sputtering method has been described, but the method for manufacturing the negative electrode active material is not limited thereto. It is also possible to use a gas phase method other than the sputtering method or a liquid phase method. As a gas phase method other than the sputtering method, for example, an atomic layer deposition (ALD) method, a vacuum evaporation method, and a Chemical Vapor Deposition (CVD) method can be used. In the case of subjecting a particulate negative electrode active material (core portion) to vapor phase film formation, it is preferable to use a rotary kiln method or a vibration method for uniform vapor phase film formation. In the case of subjecting a negative electrode active material (core portion) having a layered shape to vapor phase film formation, it is preferable to use a roll-to-roll method. As a liquid phase method, for example, a sol-gel method, an aerosol deposition method, and a spray coating method are used.

### (Modification 6)

The negative electrode active material according to the first embodiment may further contain a carbon material. In this case, excellent cycle characteristics can be obtained as well as high energy density can be obtained.

Examples of the carbon material include carbon materials such as non-graphitizable carbon, graphitizable carbon, graphite, pyrolytic carbons, cokes, glassy carbons, organic polymer compound fired bodies, carbon fibers, or activated carbon. Among these, cokes include pitch coke, needle coke, or petroleum coke. Organic polymer compound fired bodies refer to a material obtained by firing and carbonizing a polymer material such as a phenol resin or furan resin at a proper temperature. Some of these are classified as non-graphitizable carbon or graphitizable carbon. These carbon materials are preferable since a change in crystal structure thereof occurring at the time of charge and discharge significantly small and favorable cycle characteristics as well as high charge and discharge capacity can be obtained. In particular, graphite is preferable since graphite has a great electrochemical equivalent and high energy density can be obtained. In addition, non-graphitizable carbon is preferable since excellent cycle characteristics can be obtained. Furthermore, one having a low charge and discharge potential, specifically one having a charge and discharge potential close to that of lithium metal is preferable since high energy density of the battery can be easily realized.

### 2 Second Embodiment

In the second embodiment, a secondary battery including a negative electrode containing the negative electrode active material according to the first embodiment described above will be described.

### [Configuration of Battery]

Hereinafter, one configuration example of the secondary battery according to the second embodiment of the present art will be described with reference to FIG. 4. This secondary battery is, for example, a so-called lithium ion secondary battery in which the capacity of negative electrode is represented by a capacity component due to the storage and release of lithium (Li) which is an electrode reactant. This secondary battery is a so-called cylindrical secondary battery and has a wound electrode assembly 20 in which a pair of strip-shaped positive electrode 21 and strip-shaped negative electrode 22 are stacked with a separator 23 interposed therebetween and wound in an approximately hollow columnar battery can 11. The battery can 11 is composed of iron (Fe) plated with nickel (Ni), and one end portion thereof is closed and the other end portion thereof is opened. An electrolytic solution as a liquid electrolyte is injected into the interior of the battery can 11 and the positive electrode 21, the negative electrode 22, and the separator 23 are impregnated with the electrolytic solution. In addition, a pair of insulating plates 12 and 13 are respectively disposed perpendicularly with respect to the winding circumferential surface so as to sandwich the wound electrode assembly 20.

To the open end portion of the battery can 11, a battery lid 14, a safety valve mechanism 15 provided inside this battery lid 14, and a positive temperature coefficient element (PTC element) 16 are attached by being crimped with a sealing gasket 17 interposed therebetween. By this, the battery can 11 is sealed. The battery lid 14 is composed of, for example, the same material as that for the battery can 11. The safety valve mechanism 15 is electrically connected to the battery lid 14 and configured so that a disc plate 15A is inverted to cut off the electrical connection between the battery lid 14 and the wound electrode assembly 20 in a case in which the internal pressure of the battery is higher than a certain level by the internal short circuit, external heating and the like. The sealing gasket 17 is composed of, for example, an insulating material and the surface thereof is coated with asphalt.

For example, a center pin 24 is inserted at the center of the wound electrode assembly 20. A positive electrode lead 25 composed of aluminum (Al) and the like is connected to the positive electrode 21 of the wound electrode assembly 20, and a negative electrode lead 26 composed of nickel and the like is connected to the negative electrode 22. The positive electrode lead 25 is electrically connected to the battery lid 14 by being welded to the safety valve mechanism 15, and the negative electrode lead 26 is welded and electrically connected to the battery can 11.

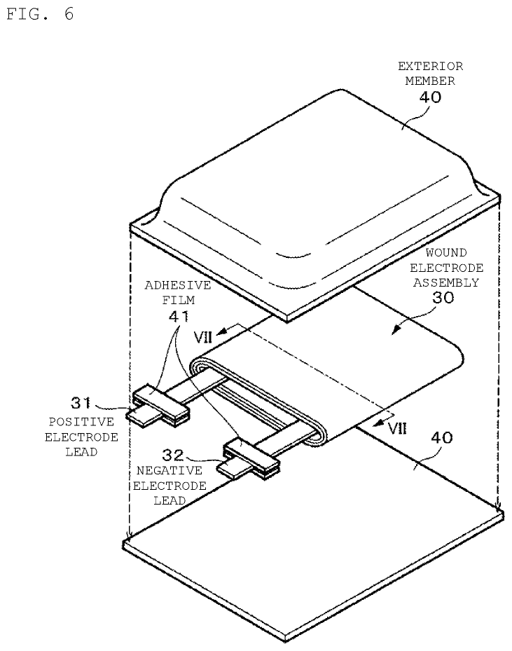

Hereinafter, the positive electrode 21, the negative electrode 22, the separator 23, and the electrolytic solution which constitute the secondary battery will be sequentially described with reference to FIG. 5.

### (Positive Electrode)

The positive electrode 21 has, for example, a structure in which a positive electrode active material layer 21B is provided on both sides of a positive electrode current collector 21A. Incidentally, the positive electrode active material layer 21B may be provided only on one side of the positive electrode current collector 21A although it is not illustrated. The positive electrode current collector 21A is composed of, for example, a metal foil such as an aluminum foil, a nickel foil, or a stainless steel foil. The positive electrode active material layer 21B contains, for example, a positive electrode active material capable of storing and releasing lithium as an electrode reactant. The positive electrode active material layer 21B may further contain additives if necessary. As the additives, for example, at least one of a conductive agent or a binder can be used.

As a positive electrode material capable of storing and releasing lithium, for example, a lithium-containing compound such as lithium oxide, lithium phosphorus oxide, lithium sulfide, or an intercalation compound containing lithium is suitable, and two or more of these may be used in mixture. In order to increase the energy density, a lithium-containing compound containing lithium, a transition metal element, and oxygen (O) is preferable. Examples of such a lithium-containing compound include a lithium composite oxide which has a layered rock salt type structure and is represented by Formula (A) and a lithium composite phosphate which has an olivine type structure and is represented by Formula (B). It is more preferable that the lithium-containing compound contains at least one selected from the group consisting of cobalt (Co), nickel, manganese (Mn), and iron as a transition metal element. Examples of such a lithium-containing compound include a lithium composite oxide which has a layered rock salt type structure and is represented by Formula (C), Formula (D), or Formula (E), a lithium composite oxide which has a spinel type structure and is represented by Formula (F), or a lithium composite phosphate which has an olivine type structure and is represented by Formula (G). Specifically, there are LiNi_{0.50}Co_{0.20}Mn_{0.30}O₂, LiₐCoO₂ (a≈1), Li_{b}CoO₂ (a≈1), Li_{c1}Ni_{c2}Co_{1-c2}O₂ (c1≈1,0<c2<1), Li_{d}Mn₂O₄ (d≈1), LiₑFePO₄ (e≈1) or the like.

LiₚNi_{(1-q-r)}Mn_{q}M1ᵣO_{(2-y)}X_{z} (A)

(Provided that, in Formula (A), M1 represents at least one of elements selected from groups 2 to 15 excluding nickel and manganese. X represents at least one of a group 16 element or a group 17 element other than oxygen. p, q, y, and z are values in ranges of 0≤p≤1.5, 0≤q≤1.0, 0≤r≤1.0, −0.10≤y≤0.20, and 0≤z≤0.2.)

LiₐM2_{b}PO₄ (B)

(Provided that, in Formula (B), M2 represents at least one of elements selected from groups 2 to 15. a and b are values in ranges of 0≤a≤2.0 and 0.5≤b≤2.0.)

Li_{f}Mn_{(1-g-h)}Ni_{g}M3ₕO₍₂₋ⱼ₎Fₖ (C)

(Provided that, in Formula (C), M3 represents at least one selected from the group consisting of cobalt, magnesium (Mg), aluminum, boron (B), titanium (Ti), vanadium (V), chromium (Cr), iron, copper (Cu), zinc (Zn), zirconium (Zr), molybdenum (Mo), tin (Sn), calcium (Ca), strontium (Sr), and tungsten (W)). f, g, h, j, and k are values in ranges of 0.8≤f≤1.2, 0<g<0.5, 0≤h≤0.5, g+h<1, −0.1≤j≤0.2, and 0≤k≤0.1. Incidentally, the composition of lithium differs depending on the state of charge and discharge and the value of f represents the value in the fully discharged state.)

LiₘNi₍₁₋ₙ₎M4ₙO₍₂₋ₚ₎F_{q} (D)

(Provided that, in Formula (D), M4 represents at least one selected from the group consisting of cobalt, manganese, magnesium, aluminum, boron, titanium, vanadium, chromium, iron, copper, zinc, molybdenum, tin, calcium, strontium, and tungsten. m, n, p, and q are values in ranges of 0.8≤m≤1.2, 0.005≤n≤0.5, −0.1≤p≤0.2, and 0≤q≤0.1. Incidentally, the composition of lithium differs depending on the state of charge and discharge and the value of m represents the value in the fully discharged state.)

LiᵣCO₍₁₋ₛ₎M5ₛO₍₂₋ₜ₎Fᵤ (E)

(Provided that, in Formula (E), M5 represents at least one selected from the group consisting of nickel, manganese, magnesium, aluminum, boron, titanium, vanadium, chromium, iron, copper, zinc, molybdenum, tin, calcium, strontium, and tungsten. r, s, t, and u are values in ranges of 0.8≤r≤1.2, 0≤s<0.5, −0.1≤t≤0.2, and 0≤u≤0.1. Incidentally, the composition of lithium differs depending on the state of charge and discharge and the value of r represents the value in the fully discharged state.)

LiᵥMn_{2-w}M6_{w}OₓF_{y} (F)

(Provided that, in Formula (F), M6 represents at least one selected from the group consisting of cobalt, nickel, magnesium, aluminum, boron, titanium, vanadium, chromium, iron, copper, zinc, molybdenum, tin, calcium, strontium, and tungsten. v, w, x, and y are values in ranges of 0.9≤v≤1.1, 0≤w≤0.6, 3.7≤x≤4.1, and 0≤y≤0.1. Incidentally, the composition of lithium differs depending on the state of charge and discharge and the value of v represents the value in the fully discharged state.)

Li_{z}M7PO₄ (G)

(Provided that, in Formula (G), M7 represents at least one selected from the group consisting of cobalt, manganese, iron, nickel, magnesium, aluminum, boron, titanium, vanadium, niobium (Nb), copper, zinc, molybdenum, calcium, strontium, tungsten, and zirconium. z is a value in a range of 0.9≤z≤1.1. Incidentally, the composition of lithium differs depending on the state of charge and discharge and the value of z represents the value in the fully discharged state.)

As the lithium composite oxide containing Ni, a lithium composite oxide (NCM) containing lithium, nickel, cobalt, manganese, and oxygen, a lithium composite oxide (NCA) containing lithium, nickel, cobalt, aluminum, and oxygen and the like may be used. Specifically, those represented by the following Formula (H) or Formula (I) may be used as the lithium composite oxide containing Ni.

Liᵥ₁Ni_{w1}M1′ₓ₁O_{z1} (H)

(Where 0<v1<2, w1+x1≤1, 0.2≤w1≤1, 0≤x1≤0.7, and 0<z<3 are satisfied, and M1′ represents at least one or more elements consisting of transition metals such as cobalt, iron, manganese, copper, zinc, aluminum, chromium, vanadium, titanium, magnesium, and zirconium.)

Liᵥ₂Ni_{w2}M2′ₓ₂O_{z2} (I)

(Where 0<v2<2, w2+x2≤1, 0.65≤w2≤1, 0≤x2≤0.35, and 0<z2<3 are satisfied, and M2′ represents at least one or more elements consisting of transition metals such as cobalt, iron, manganese, copper, zinc, aluminum, chromium, vanadium, titanium, magnesium, and zirconium.)

Examples of the positive electrode material capable of storing and releasing lithium also include inorganic compounds which do not contain lithium such as MnO₂, V₂O₅, V₆O₁₃, NiS, and MoS in addition to these.

The positive electrode material capable of storing and releasing lithium may be positive electrode materials other than those described above. In addition, two or more kinds of positive electrode materials exemplified above may be mixed by arbitrary combinations.

As the binder, for example, at least one selected from resin materials such as polyvinylidene fluoride (PVdF), polytetrafluoroethylene (PTFE), polyacrylonitrile (PAN), styrene-butadiene rubber (SBR), and carboxymethyl cellulose (CMC) and copolymers containing these resin materials as a main constituent is used.

Examples of the conductive agent include carbon materials such as graphite, carbon black, and ketjen black, and one among these may be used or two or more among these may be used in mixture. In addition to the carbon materials, a metal material, a conductive polymer material or the like may be used as long as the material exhibits conductivity.

### (Negative Electrode)

The negative electrode 22 has, for example, a structure in which a negative electrode active material layer 22B is provided on both sides of a negative electrode current collector 22A. Incidentally, the negative electrode active material layer 22B may be provided only on one side of the negative electrode current collector 22A although it is not illustrated. The negative electrode current collector 22A is composed of, for example, a metal foil such as a copper foil, a nickel foil, or a stainless steel foil.

The negative electrode active material layer 22B contains one or two or more negative electrode active materials capable of storing and releasing lithium. The negative electrode active material layer 22B may further contain additives such as a binder and a conductive agent if necessary.

Incidentally, in this secondary battery, it is preferable that the electrochemical equivalent of the negative electrode 22 or the negative electrode active material is greater than the electrochemical equivalent of the positive electrode 21 and the lithium metal is not deposited on the negative electrode 22 during charge in theory.

As the negative electrode active material, the negative electrode active material according to the first embodiment or a modification thereof is used.

As the binder, for example, at least one selected from resin materials such as polyvinylidene fluoride, polytetrafluoroethylene, polyacrylonitrile, styrene-butadiene rubber, and carboxymethyl cellulose and copolymers containing these resin materials as a main constituent is used. As the conductive agent, the same carbon material as that in the positive electrode active material layer 21B can be used.

### (Separator)

The separator 23 separates the positive electrode 21 and the negative electrode 22 from each other and allows lithium ions to pass therethrough while preventing a short circuit of current due to the contact of both electrodes. The separator 23 is composed of, for example, a porous membrane made of a resin such as polytetrafluoroethylene, polypropylene, or polyethylene and may have a structure in which these two or more kinds of porous membranes are laminated. Among these, polyolefin porous membrane is preferable since the polyolefin porous membrane exhibits an excellent short circuit preventing effect and can improve the safety of battery by a shutdown effect. In particular, polyethylene is preferable as a material constituting the separator 23 since a shutdown effect can be obtained in a range of 100° C. or more and 160° C. or less and polyethylene also exhibits excellent electrochemical stability. In addition to these, it is possible to use a material in which a resin exhibiting chemical stability is copolymerized or blended with polyethylene or polypropylene. Alternatively, the porous membrane may have a structure composed of three or more layers in which a polypropylene layer, a polyethylene layer, and a polypropylene layer are sequentially laminated.

The separator 23 may have a configuration including a substrate and a surface layer provided on one side or both sides of the substrate. The surface layer contains electrically insulating inorganic particles and a resin material which binds the inorganic particles to the surface of the substrate and binds the inorganic particles to each other. This resin material may have, for example, a fibrillated three-dimensional network structure in which fibrils are continuously connected to each other. The inorganic particles can be held in a dispersed state without being linked to each other by being supported on the resin material having this three-dimensional network structure. In addition, the resin material may bind the surface of the substrate and the inorganic particles without being fibrilized. In this case, higher binding property can be obtained. By providing the surface layer on one side or both sides of the substrate as described above, it is possible to impart oxidation resistance, heat resistance, and mechanical strength to the substrate.

The substrate is a porous layer exhibiting porosity. More specifically, the substrate is a porous membrane composed of an insulating membrane having a high ion permeability and a predetermined mechanical strength, and the electrolyte is retained in the holes of the substrate. It is preferable that the substrate has a predetermined mechanical strength as an essential part of the separator and is also required to exhibit high resistance to the electrolytic solution, low reactivity, and property to hardly expand.

As the resin material constituting the substrate, it is preferable to use, for example, a polyolefin resin such as polypropylene or polyethylene, an acrylic resin, a styrene resin, a polyester resin, or a nylon resin. In particular, polyethylenes such as low density polyethylene, high density polyethylene, and linear polyethylene, or low molecular weight wax components thereof or polyolefin resins such as polypropylene are suitably used since these have a proper melting temperature and are easily available. In addition, a structure in which two or more kinds of these porous membranes are laminated, or a porous membrane formed by melt-kneading two or more kinds of resin materials may be used. Those including a porous membrane composed of a polyolefin resin exhibit excellent property to separate the positive electrode 21 and negative electrode 22 from each other and can further decrease internal short circuits.

A non-woven fabric may be used as the substrate. As fibers constituting the non-woven fabric, aramid fibers, glass fibers, polyolefin fibers, polyethylene terephthalate (PET) fibers, nylon fibers and the like can be used. Moreover, the non-woven fabric may be fabricated by mixing two or more kinds of these fibers.

The inorganic particles contain at least one of a metal oxide, a metal nitride, a metal carbide, or a metal sulfide. As the metal oxide, aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂), yttrium oxide (yttria, Y₂O₃) or the like can be suitably used. As the metal nitride, silicon nitride (Si₃N₄), aluminum nitride (AlN), boron nitride (BN), titanium nitride (TiN) or the like can be suitably used. As the metal carbide, silicon carbide (SiC), boron carbide (B4C) or the like can be suitably used. As the metal sulfide, barium sulfate (BaSO₄) or the like can be suitably used. Moreover, porous aluminosilicates such as zeolite (M_{2/n}O*Al₂O₃.xSiO₂.yH₂O, M is a metal element, x≥2, and y≥0), layered silicates, minerals such as barium titanate (BaTiO₃) or strontium titanate (SrTiO₃) and the like may be used. Among these, alumina, titania (in particular, one having a rutile structure), silica, or magnesia is preferably used, and alumina is more preferably used. The inorganic particles exhibit oxidation resistance and heat resistance, and the surface layer on the side facing the positive electrode containing the inorganic particles exhibits high resistance to the oxidizing environment in the vicinity of the positive electrode at the time of charge. The shape of the inorganic particles is not particularly limited, and inorganic particles having any of a spherical shape, a plate shape, a fibrous shape, a cubic shape, or a random shape can be used.

Examples of the resin material constituting the surface layer include a fluorine-containing resin such as polyvinylidene fluoride or polytetrafluoroethylene, fluorine-containing rubber such as a vinylidene fluoride-tetrafluoroethylene copolymer or an ethylene-tetrafluoroethylene copolymer, rubber such as a styrene-butadiene copolymer or a hydride thereof, an acrylonitrile-butadiene copolymer or a hydride thereof, an acrylonitrile-butadiene-styrene copolymer or a hydride thereof, a methacrylic acid ester-acrylic acid ester copolymer, a styrene-acrylic acid ester copolymer, an acrylonitrile-acrylic acid ester copolymer, ethylene propylene rubber, polyvinyl alcohol, or polyvinyl acetate, cellulose derivatives such as ethyl cellulose, methyl cellulose, hydroxyethyl cellulose, and carboxymethyl cellulose, polyphenylene ether, polysulfone, polyether sulfone, polyphenylene sulfide, polyether imide, polyimide, polyamide such as wholly aromatic polyamide (aramid), polyamide imide, polyacrylonitrile, polyvinyl alcohol, polyether, and a resin exhibiting high heat resistance so that at least one of a melting point or a glass transition temperature is 180° C. or higher such as an acrylic resin or polyester. These resin materials may be used singly or two or more kinds thereof may be used in mixture. Among these, a fluorine-based resin such as polyvinylidene fluoride is preferable from the viewpoint of oxidation resistance and flexibility, and it is preferable to contain aramid or polyamideimide from the viewpoint of heat resistance.

The particle size of inorganic particles is preferably in a range of 1 nm to 10 μm. When the particle size is smaller than 1 nm, it is difficult to procure the inorganic particles and it is not cost effective even if the inorganic particles can be procured. On the other hand, when the particle size is larger than 10 μm, the distance between the electrodes increases, a sufficient filling amount of active material cannot be attained in a limited space, and the battery capacity decreases.

As a method for forming the surface layer, for example, it is possible to use a method in which a substrate (porous membrane) is coated with a slurry composed of a matrix resin, a solvent, and an inorganic material, and the coated substrate is allowed to pass through a tub containing a solvent which is a poor solvent of the matrix resin and a good solvent of the above solvent for phase separation, and then the coating film is dried.

Incidentally, the inorganic particles described above may be contained in the porous membrane as a substrate. In addition, the surface layer may be composed only of a resin material without containing inorganic particles.

### (Electrolytic Solution)

The separator 23 is impregnated with an electrolytic solution which is a liquid electrolyte. The electrolytic solution contains a solvent and an electrolyte salt dissolved in this solvent. The electrolytic solution may contain known additives in order to improve the battery characteristics.

As the solvent, cyclic carbonates such as ethylene carbonate and propylene carbonate can be used, and it is preferable to use one of ethylene carbonate or propylene carbonate, particularly, both of these in mixture. This is because the cycle characteristics can be improved.

As the solvent, it is preferable to use chain carbonates such as diethyl carbonate, dimethyl carbonate, ethylmethyl carbonate, and methylpropyl carbonate in mixture in addition to these cyclic carbonates. This is because high ion conductivity can be obtained.

It is preferable that the solvent further contains 2,4-difluoroanisole or vinylene carbonate. This is because 2,4-difluoroanisole can improve the discharge capacity and vinylene carbonate can improve the cycle characteristics. Hence, it is preferable to use these in mixture since the discharge capacity and cycle characteristics can be improved.

In addition to these, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxy acetonitrile, 3-methoxy propyronitrile, N,N-dimethylformamide, N-methyl pyrrolidinone, N-methyloxazolidinone, N,N-dimethylimidazolidinone, nitromethane, nitroethane, sulfolane, dimethyl sulfoxide, or trimethyl phosphate.

Incidentally, compounds obtained by substituting at least a part of hydrogen in these non-aqueous solvents with fluorine are preferable in some cases since there is a case in which the reversibility of electrode reaction can be improved depending on the kind of electrode to be combined.

The electrolytic solution may further contain one or more selected from the group consisting of halogenated carbonates, unsaturated cyclic carbonates, sultones (cyclic sulfonates), lithium difluorophosphate (LiPF₂O₂), and lithium monofluorophosphate (Li₂PFO₃).

Halogenated carbonates are carbonates containing one or two or more halogens as a constituent element. Examples of the halogenated carbonates include at least one of halogenated carbonates represented by the following Formulas (1) and (2).

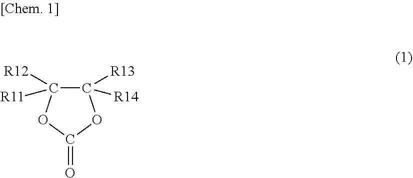

(In Formula (3), R11 to R14 each independently represent a hydrogen group, a halogen group, a monovalent hydrocarbon group, or a monovalent halogenated hydrocarbon group, and at least one of R11 to R14 is a halogen group or a monovalent halogenated hydrocarbon group.)

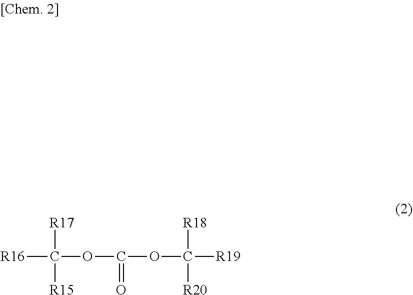

(In Formula (2), R15 to R20 each independently represent a hydrogen group, a halogen group, a monovalent hydrocarbon group, or a monovalent halogenated hydrocarbon group, and at least one of R15 to R20 is a halogen group or a monovalent halogenated hydrocarbon group.)

The halogenated carbonates represented by Formula (1) are cyclic carbonates (halogenated cyclic carbonates) containing one or two or more halogens as a constituent element. The halogenated carbonates represented by Formula (2) are chain carbonates (halogenated chain carbonates) containing one or two or more halogens as a constituent element.

Examples of the monovalent hydrocarbon group include an alkyl group. Examples of the monovalent halogenated hydrocarbon group include a halogen alkyl group. The kind of halogen is not particularly limited, but among them, fluorine (F), chlorine (Cl), or bromine (Br) is preferable, and fluorine is more preferable. This is because fluorine is more highly effective than other halogens. However, the number of halogens is preferably two rather than one and may be three or more. This is because the ability to form a protective film is increased, a firmer and stable protective film is formed, and thus the decomposition reaction of the electrolytic solution is further suppressed.

Examples of halogenated cyclic carbonates represented by Formula (1) include 4-fluoro-1,3-dioxolan-2-one (FEC (fluoroethylene carbonate)), 4-chloro-1,3-dioxolane 2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-oxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2-one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one, 4-fluoro-4-methyl-1,3-dioxolane-2-one. These may be used singly or a plurality of these may be used in mixture. These halogenated cyclic carbonates also include geometric isomers. For example, for 4,5-difluoro-1,3-dioxolan-2-one, the trans isomer is preferred to the cis isomer. This is because the trans isomer is highly effective as well as is easily available. Examples of the halogenated chain carbonates represented by Formula (2) include fluoromethyl methyl carbonate, bis(fluoromethyl) carbonate, and difluoromethyl methyl carbonate. These may be used singly or a plurality of these may be used in mixture.

An unsaturated cyclic carbonate is a cyclic carbonate containing one or two or more unsaturated carbon bonds (carbon-carbon double bonds). Examples of the unsaturated cyclic carbonate include compounds represented by Formula (3) such as methylene ethylene carbonate (4MEC: 4-methylene-1,3-dioxolan-2-one), vinylene carbonate (VC: vinylene carbonate), and vinyl ethylene carbonate.

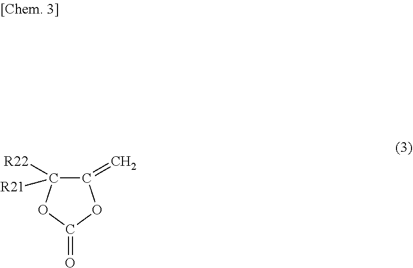

(In Formula (3), R21 and R22 each independently represent a hydrogen group, a halogen group, a monovalent hydrocarbon group, or a monovalent halogenated hydrocarbon group.)

Examples of sultones include compounds represented by Formula (4). Examples of the compounds represented by Formula (4) include propane sultone (PS: 1,3-propane sultone) or propene sultone (PRS: 1,3-propene sultone).

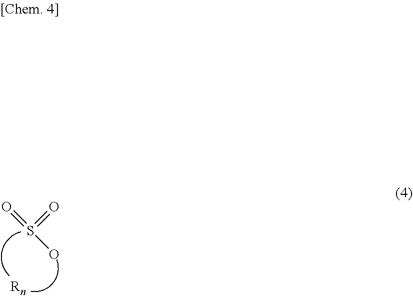

(In Formula (4), Rn represents a divalent hydrocarbon group which has n carbon atoms and forms a ring together with S (sulfur) and O (oxygen). n represents 2 to 5. The ring may have an unsaturated double bond.)

Examples of the electrolyte salt include lithium salts. One kind may be used singly or two or more kinds may be used in mixture. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bis(oxalate)borate, and LiBr. Among these, LiPF₆ is preferable since the cycle characteristics can be improved as well as high ion conductivity can be obtained.

### [Battery Voltage]

In the secondary battery according to the second embodiment, the open circuit voltage (namely, battery voltage) in the fully charged state for one pair of positive electrode 21 and negative electrode 22 may be 4.2 V or less, but the secondary battery may be designed so that the open circuit voltage is preferably 4.25 V or more, more preferably 4.3 V, and still more preferably 4.4 V or more. By setting the battery voltage high, high energy density can be obtained. The upper limit value of the open circuit voltage in the fully charged state for one pair of positive electrode 21 and negative electrode 22 is preferably 6.00 V or less, more preferably 4.60 V or less, and still more preferably 4.50 V or less.

### [Operation of Battery]

In the non-aqueous electrolyte secondary battery having the configuration described above, for example, lithium ions are released from the positive electrode active material layer 21B, pass through the electrolytic solution, and are stored in the negative electrode active material layer 22B when charge is performed. In addition, for example, lithium ions are released from the negative electrode active material layer 22B, pass through the electrolytic solution, and are stored in the positive electrode active material layer 21B when discharge is performed.

### [Method for Manufacturing Battery]

Next, an example of a method for manufacturing the secondary battery according to the second embodiment of the present art will be described.

First, for example, a positive electrode active material, a conductive agent, and a binder are mixed together to prepare a positive electrode mixture, and this positive electrode mixture is dispersed in a solvent such as N-methyl-2-pyrrolidone (NMP) to prepare a paste-like positive electrode mixture slurry. Next, the positive electrode current collector 21A is coated with this positive electrode mixture slurry, the solvent is dried, and compression molding is performed using a roll press machine or the like to form the positive electrode active material layer 21B, whereby the positive electrode 21 is fabricated.

In addition, for example, the negative electrode active material according to the first embodiment and a binder are mixed together to prepare a negative electrode mixture, and this negative electrode mixture is dispersed in a solvent such as N-methyl-2-pyrrolidone to prepare a paste-like negative electrode mixture slurry. Next, the negative electrode current collector 22A is coated with this negative electrode mixture slurry, the solvent is dried, and compression molding is performed using a roll press machine or the like to form the negative electrode active material layer 22B, whereby the negative electrode 22 is fabricated.

Next, the negative electrode lead 26 is attached to the negative electrode current collector 22A by welding or the like as well as the positive electrode lead 25 is attached to the positive electrode current collector 21A by welding or the like. Next, the positive electrode 21 and the negative electrode 22 are wound with the separator 23 interposed therebetween. Next, the tip portion of the negative electrode lead 26 is welded to the battery can 11 as well as the tip portion of the positive electrode lead 25 is welded to the safety valve mechanism 15, and the wound positive electrode 21 and negative electrode 22 are sandwiched between the pair of insulating plates 12 and 13 and accommodated inside the battery can 11. Next, after the positive electrode 21 and the negative electrode 22 are accommodated inside the battery can 11, the electrolytic solution is injected into the battery can 11 and the separator 23 is impregnates with the electrolytic solution. Next, the battery lid 14, the safety valve mechanism 15, and a positive temperature coefficient element 16 are fixed to the open end portion of the battery can 11 by being crimped with the sealing gasket 17 interposed therebetween. In this manner, the secondary battery illustrated in FIG. 4 is obtained.

### [Effect]

The battery according to the second embodiment includes the negative electrode 22 containing the negative electrode active material according to the first embodiment, and thus the cycle characteristics can be ameliorated. In addition, it is also possible to maintain the load characteristics (load characteristics after repeated cycles) by a decrease in cell resistance.

### 3 Third Embodiment

### [Configuration of Battery]

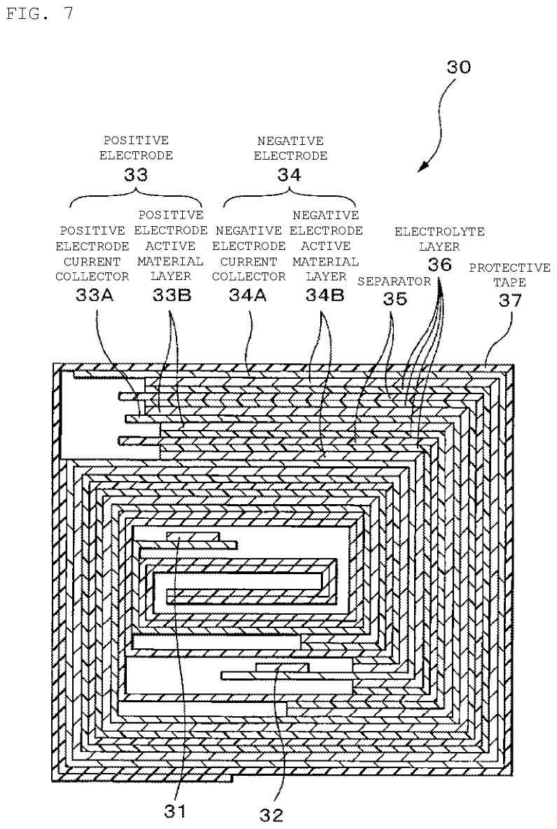

FIG. 6 is an exploded perspective diagram illustrating a configuration example of the secondary battery according to the third embodiment of the present art. This secondary battery is a so-called flatten or square type secondary battery, is a secondary battery in which a wound electrode assembly 30 to which a positive electrode lead 31 and a negative electrode lead 32 are attached is accommodated inside a film-shape exterior member 40, and can be miniaturized, decreased in weight, and thinned.

The positive electrode lead 31 and the negative electrode lead 32 are respectively led from the inside to the outside of the exterior member 40, for example, in the same direction. The positive electrode lead 31 and the negative electrode lead 32 are respectively composed of, for example, a metal material such as aluminum, copper, nickel, or stainless steel and respectively have a thin plate shape or a mesh shape.

The exterior member 40 is composed of, for example, a rectangular aluminum laminated film in which a nylon film, an aluminum foil, and a polyethylene film are pasted together in this order. The exterior member 40 is disposed, for example, so that the polyethylene film side and the wound electrode assembly 30 face each other, and the respective outer edge portions are closely stuck to each other by fusion or using an adhesive agent. An adhesive film 41 to prevent the outside air from entering is inserted between the exterior member 40 and the positive electrode lead 31 and negative electrode lead 32. The adhesive film 41 is composed of a material exhibiting adhesive property to the positive electrode lead 31 and the negative electrode lead 32, for example, a polyolefin resin such as polyethylene, polypropylene, modified polyethylene, or modified polypropylene.

Incidentally, the exterior member 40 may be composed of a laminated film having another structure, a polymer film such as polypropylene, or a metal film instead of the aluminum laminated film described above. Alternatively, a laminated film in which a polymer film is laminated on one side or both sides of an aluminum film as a core material may be used.

FIG. 7 is a cross-sectional diagram of the wound electrode assembly 30 taken along the line VII-VII in FIG. 6. The wound electrode assembly 30 is fabricated by stacking a positive electrode 33 and a negative electrode 34 with a separator 35 and an electrolyte layer 36 interposed therebetween and winding the stacked body, and the outermost circumferential portion is protected by a protective tape 37.

The positive electrode 33 has, for example, a structure in which a positive electrode active material layer 33B is provided on one side or both sides of a positive electrode current collector 33A. The negative electrode 34 has a structure in which a negative electrode active material layer 34B is provided on one side or both sides of a negative electrode current collector 34A, and the negative electrode active material layer 34B and the positive electrode active material layer 33B are disposed so as to face each other. The configurations of the positive electrode current collector 33A, positive electrode active material layer 33B, negative electrode current collector 34A, negative electrode active material layer 34B, and the separator 35 are the same as those of the positive electrode current collector 21A, positive electrode active material layer 21B, negative electrode current collector 22A, negative electrode active material layer 22B, and the separator 23 in the second embodiment, respectively.

The electrolyte layer 36 contains an electrolytic solution and a polymer compound to be a retainer which retains this electrolytic solution and is in a so-called gel state. The gel electrolyte layer 36 is preferable since it is possible to prevent liquid leakage from the battery as well as to obtain a high ion conductivity. The electrolytic solution is the electrolytic solution according to the first embodiment. Examples of the polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, or polycarbonate. In particular, polyacrylonitrile, polyvinylidene fluoride, polyhexafluoropropylene, or polyethylene oxide is preferable from the viewpoint of electrochemical stability.

Incidentally, the same inorganic material as the inorganic material mentioned in the description of the resin layer of the separator 23 in the second embodiment may be contained in the gel electrolyte layer 36. This is because the heat resistance can be further improved. Moreover, an electrolytic solution may be used instead of the electrolyte layer 36.

### [Method for Manufacturing Battery]

Next, an example of a method for manufacturing the secondary battery according to the third embodiment of the present art will be described.

First, the positive electrode 33 and the negative electrode 34 are each coated with a precursor solution containing a solvent, an electrolyte salt, a polymer compound, and a mixed solvent, and the mixed solvent is evaporated to form the electrolyte layer 36. Next, the negative electrode lead 32 is attached to the end portion of the negative electrode current collector 34A by welding as well as the positive electrode lead 31 is attached to the end portion of the positive electrode current collector 33A by welding. Next, the positive electrode 33 and negative electrode 34 on which the electrolyte layer 36 is formed are stacked with the separator 35 interposed therebetween to obtain a stacked body, then this stacked body is wound in the longitudinal direction, and the protective tape 37 is pasted to the outermost circumferential portion to form the wound electrode assembly 30. Finally, for example, the wound electrode assembly 30 is sandwiched between the exterior members 40, and the outer edge portions of the exterior member 40 are closely stuck to each other by heat seal and the like to seal the exterior member. At this time, the adhesive film 41 is inserted between the positive electrode lead 31 and negative electrode lead 32 and the exterior member 40. In this manner, the secondary battery illustrated in FIG. 6 and FIG. 7 is obtained.

In addition, this secondary battery may be fabricated as follows. First, the positive electrode 33 and the negative electrode 34 are fabricated as described above, and the positive electrode lead 31 and the negative electrode lead 32 are attached to the positive electrode 33 and the negative electrode 34. Next, the positive electrode 33 and the negative electrode 34 are stacked with the separator 35 interposed therebetween, the stacked body is wound, and the protective tape 37 is pasted to the outermost circumferential portion to form a wound assembly. Next, this wound assembly is sandwiched between the exterior members 40, and the outer circumferential edge portion excluding one side is heat-sealed to have a bag shape, whereby the wound assembly is accommodated inside the exterior member 40. Next, a composition for electrolyte containing a solvent, an electrolyte salt, a monomer which is a raw material of a polymer compound, a polymerization initiator, and, if necessary, other materials such as a polymerization inhibitor, is prepared and injected into the exterior member 40.

Next, after the composition for electrolyte is injected into the exterior member 40, the opening of the exterior member 40 is hermetically sealed by heat seal in a vacuum atmosphere. Next, the monomer is polymerized by heating to obtain a polymer compound, whereby the gel electrolyte layer 36 is formed. In this manner, the secondary battery illustrated in FIG. 7 is obtained.

### EXAMPLES

Hereinafter, the present art will be specifically described with reference to Examples, but the present art is not limited only to these Examples.

### Example 1

### [Fabrication of Negative Electrode Active Material]

First, powder of SiOₓ particles (manufactured by KOJUNDO CHEMICAL LABORATORY CO., LTD.) was prepared. Next, the surface of the SiOₓ particles was covered with Li₃PO₄ using the sputtering apparatus for powder covering illustrated in FIG. 2. Specifically, argon ions were accelerated and collided to the target and the ionized target material molecules (or atoms) were deposited on the surface of SiOₓ particles as a substrate by a RF (radio frequency) magnetron sputtering method using a Li₃PO₄ sintered body target having a diameter of 4 inches. At this time, uniform covering was realized by moving the powder using a vibrator. However, the deposition rate is slow (about 1 nm/h), covering in a thickness of 10 nm or more is not realistic. In the present example, ______, covering in a thickness of 3 to 5 nm was performed.

In Example 1, Li₃PO₄, which was an oxide solid electrolyte, was adopted as the material for the covering portion from the viewpoint of the Li ion conductivity and the adhesive property to Si oxide. As illustrated in Table 1, a low interface stress is expected since Li₃PO₄ exhibits the same Li ion conductivity as that of LiSiₓO_{y} (SiOₓ component after charge) and also has a Young's modulus value close to that of LiSiₓO_{y}. In addition, it is considered that Li₃PO₄ is a promising covering material since Li₃PO₄ and LiSiₓO_{y} are materials exhibiting mutual compatibility and the Li₃PO₄—Li₄SiO₄-based mixed glass exhibits a Li ion conductivity of 2×10⁻⁵ S/cm to be 1000-folds that of a single substance thereof.

Table 1 presents the physical properties of Li₃PO₄ and LiSiₓO_{y}.

TABLE 1

| | Li₃PO₄ | LiSixOy |
|---|---|---|
| Li ion conductivity (S/cm) | 1 × 10⁻⁸ | 4 × 10⁻⁸ |
| Young's modulus (GPa) | ~50 | ~70 |

### [Fabrication of Battery]

A coin type half cell (hereinafter referred to as “coin cell”), which had a 2016 size (size having a diameter of 20 mm and a height of 1.6 mm) and included a negative electrode containing the powder of Li₃PO₄-covered SiOₓ particles obtained as described above as a working electrode and a lithium metal foil as a counter electrode, was fabricated as follows.

First, the negative electrode active material of Example 1-1 and a polyimide varnish were weighed so that the mass ratio (negative electrode active material:polyimide varnish) was 7:2 and these were dispersed in a proper amount of N-methyl-2-pyrrolidone (NMP) to prepare a negative electrode mixture slurry.

Next, the prepared negative electrode mixture slurry was applied onto a copper foil (negative electrode current collector) and then dried at 700° C. in a vacuum firing furnace to form a negative electrode active material layer on the copper foil, whereby a negative electrode was obtained. Next, this negative electrode was punched into a circular shape having a diameter of 15 mm and then compressed using a press machine. In this manner, the intended negative electrode was obtained.

Next, a lithium metal foil punched into a circular shape having a diameter of 15 mm was prepared as a counter electrode. Next, a microporous polyethylene film was prepared as a separator. Next, a non-aqueous electrolytic solution was prepared by dissolving LiPF₆ as an electrolyte salt in a solvent in which ethylene carbonate (EC), fluoroethylene carbonate (FEC), and dimethyl carbonate (DMC) were mixed together so as to have a mass ratio (EC:FEC:DMC) of 40:10:50 so that the concentration of LiPF₆ was 1 mol/kg.

Finally, the fabricated positive electrode and negative electrode were stacked with the microporous film interposed therebetween to obtain a stacked body, and the non-aqueous electrolytic solution was accommodated inside the exterior cup and the exterior can together with this stacked body and crimped with a gasket interposed therebetween. In this manner, the intended coin cell was obtained.

### Example 2

First, a powder of Si particles was prepared as a negative electrode active material. Next, the surface of the Si particles was covered with Li₃PO₄ using the sputtering apparatus for powder covering illustrated in FIG. 2. Incidentally, a Si target was used as the target. A coin cell was obtained in the same manner as Example 1 except that the powder of Li₃PO₄-covered Si particles obtained as described above was used as a negative electrode active material.

### Example 3

One not containing FEC was used as the electrolytic solution. Specifically, a non-aqueous electrolytic solution was prepared by dissolving LiPF₆ as an electrolyte salt in a solvent in which EC and DMC were mixed together so as to have a mass ratio (EC:DMC) of 40:50 at a concentration of 1 mol/kg. A coin cell was obtained in the same manner as in Example 1 except this.

### Comparative Example 1

A coin cell was obtained in the same manner as Example 1 except that a powder of SiOₓ particles (manufactured by KOJUNDO CHEMICAL LABORATORY CO., LTD.) was not covered with Li₃PO₄ but was used as a negative electrode active material as it was.

### Comparative Example 2

A coin cell was obtained in the same manner as Example 2 except that a powder of Si particles was not covered with Li₃PO₄ but was used as a negative electrode active material as it was.

### Comparative Example 3

A coin cell was obtained in the same manner as Example 1 except that a powder of carbon-covered SiOₓ particles (manufactured by KOJUNDO CHEMICAL LABORATORY CO., LTD.) was used as a negative electrode active material.

### Comparative Example 4

A coin cell was obtained in the same manner as Example 1 except that a powder of heat-treated SiOₓ particles was used as a negative electrode active material. Incidentally, a powder of heat-treated SiOₓ particles was obtained by subjecting a powder of SiOₓ particles (manufactured by KOJUNDO CHEMICAL LABORATORY CO., LTD.) to a heat treatment.

### Comparative Example 5

A coin cell was obtained in the same manner as Example 1 except that a powder of heat-treated carbon-covered SiOₓ particles was used as a negative electrode active material. Incidentally, a powder of heat-treated carbon-covered SiOₓ particles was obtained by subjecting a powder of carbon-covered SiOₓ particles (manufactured by KOJUNDO CHEMICAL LABORATORY CO., LTD.) to a heat treatment.

### Comparative Example 6

One not containing FEC was used as the electrolytic solution. Specifically, a non-aqueous electrolytic solution was prepared by dissolving LiPF₆ as an electrolyte salt in a solvent in which EC and DMC were mixed together so as to have a mass ratio (EC:DMC) of 40:50 at a concentration of 1 mol/kg. A coin cell was obtained in the same manner as in Comparative Example 1 except this.

### [Evaluation of Negative Electrode Active Material]

### (XPS Depth Analysis)

The negative electrode active material (Li₃PO₄-covered SiOₓ particles) used in Example 1 described above was subjected to depth analysis by XPS (X-ray Photoelectron Spectroscopy). The measurement conditions of XPS are presented below.

Instrument: JEOL JPS9010

Measurement: wide scan, narrow scan (Si2p, P2p, C1s, O1s).

All peaks were corrected at 248.6 eV of C1s, and the bonding state was analyzed by performing background elimination and peak fitting. In addition, for the depth analysis, gas phase etching with argon ions was performed in-situ and XPS analysis in the thickness direction was performed.

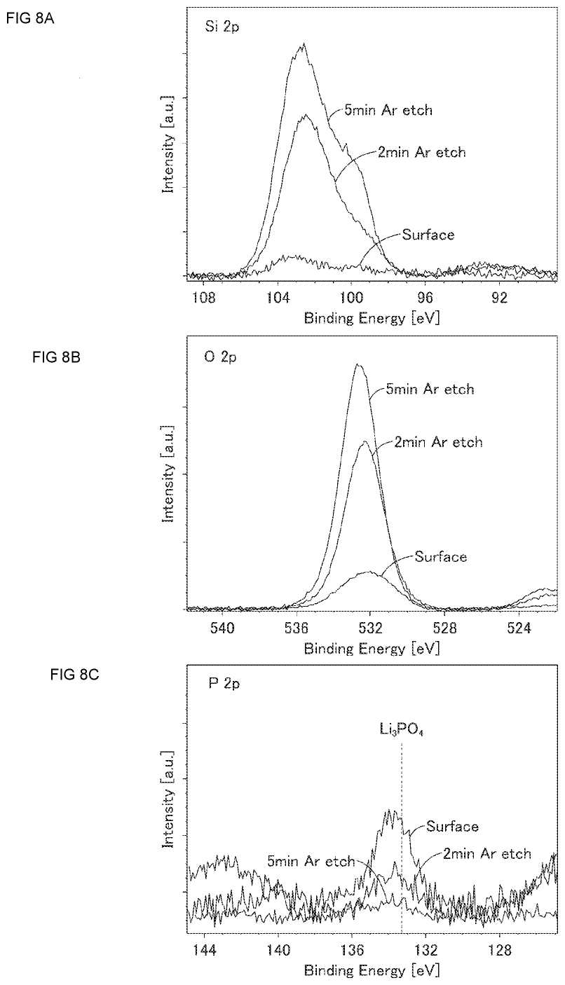

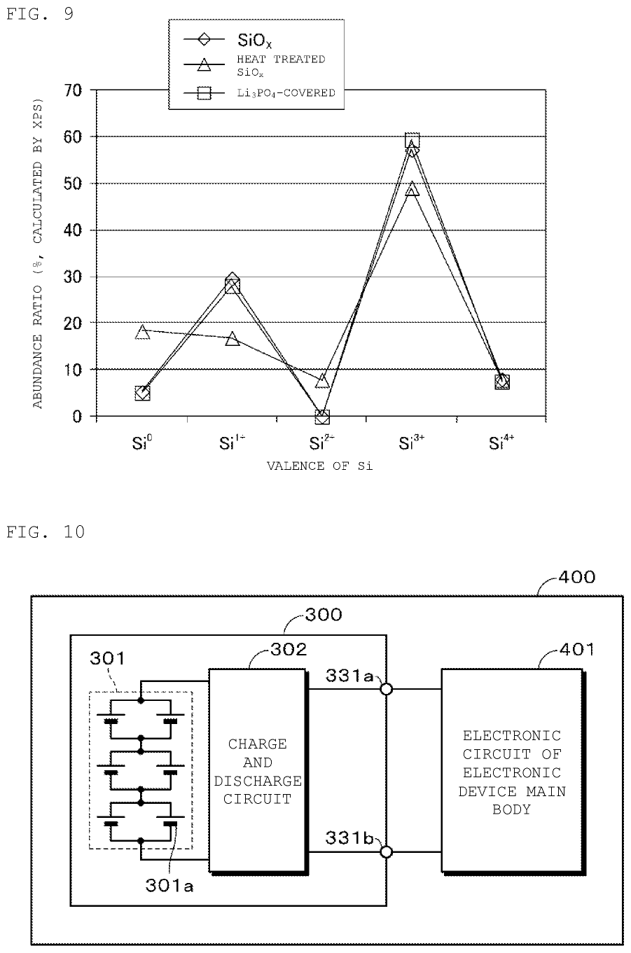

FIG. 8 is a graph illustrating the results on the XPS depth analysis of Li₃PO₄-covered SiOₓ particles. As supposed, a peak attributed to Li₃PO₄ was detected and the SiOₓ peak was small on the outermost surface, and Li₃PO₄ disappeared and an increase in SiOₓ was observed in a depth equivalent to several nm. From this result, it can be seen that the surface of the SiOₓ particles was relatively uniformly covered with Li₃PO₄ having a thickness of several nm.

### (XPS Valence Analysis)

The negative electrode active material (Li₃PO₄-covered SiOₓ particles) used in Example 1 described above and the negative electrode active materials (SiOₓ particles, heat-treated SiOₓ particles) used in Comparative Examples 1 and 4 were subjected to Ar etching and then to the analysis of Si valence inside the SiOₓ particles by XPS (X-ray Photoelectron Spectroscopy).

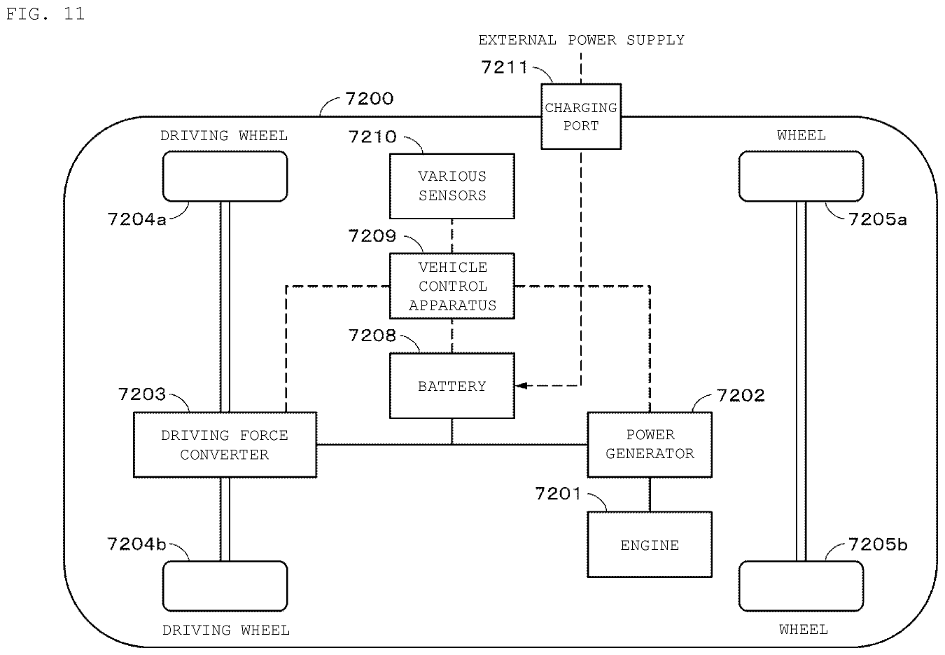

FIG. 9 is a graph illustrating the results on the XPS valence analysis of Li₃PO₄-covered SiOₓ particles, SiOₓ particles, and heat-treated SiOₓ particles. Si₀ and Si₁₊ of the heat-treated SiOₓ particles were changed with respect to Si₀ and Si₁₊ of the SiOₓ particles, that is, reduction proceeded, but Si₀ and Si₁₊ of the Li₃PO₄-covered SiOₓ particles were not changed with respect to Si₀ and Si₁₊ of the SiOₓ particles, that is, a change in SiOₓ bulk was not observed.

### [Evaluation of Coin Cell]

The coin cells of Examples 1 to 3 and Comparative Examples 1 to 6 were subjected to a 50-cycle charge and discharge test, and the initial charge capacity, initial discharge capacity, initial charge and discharge efficiency, capacity retention rate at the 50th cycle, charge and discharge efficiency at the 50th cycle, open circuit voltage after discharge at the 50th cycle, and impedance at the 50th cycle of the coin cells were determined.

The conditions of the charge and discharge test are presented below.

### [Initial Efficiency]

Charge: 0 V CCCV(Constant Current/Constant Voltage) 0.05 C 0.04 mA cut

Discharge: CC(Constant Current) 1.5 V 0.05 C

### [Cycle Characteristics]

In the cycle characteristics, the following charge and discharge test is repeated up to 50 cycles.

### Charge: 0 V CCCV(Constant Current/Constant Voltage) 0.5 C 0.025 C cut

### Discharge: CC(Constant Current) 1.5 V 0.5 C

The initial charge and discharge efficiency and cycle characteristics (capacity retention rate at the 50th cycle, charge and discharge efficiency at the 50th cycle) were respectively determined by the following equations.

Initial charge and discharge efficiency [%]=(initial discharge capacity/initial charge capacity)×100

Capacity retention rate at 50th cycle [%]=(discharge capacity at 50th cycle/discharge capacity at first cycle)×100

Charge and discharge efficiency at 50th cycle [%]=(discharge capacity at 50th cycle/charge capacity at 50th cycle)×100

Incidentally, in the above equations for calculating the capacity retention rate at the 50th cycle and the charge and discharge efficiency at the 50th cycle, the “first cycle” and the “50th cycle” mean the first cycle and the 50th cycle in the above cycle characteristics, respectively.

For the impedance at the 50th cycle, after the 50th cycle of charge and discharge was terminated, AC impedance was measured at a room temperature of 25° C. and a Cole-Cole plot was created. The impedance at the 50th cycle presented in Table 2 is a numerical value at a frequency of 1 kHz.

Table 2 presents the evaluation results for the coin cells of Examples 1 and 2 and Comparative Examples 1 to 5.

TABLE 2

| | | | | | Initial | Capacity | Charge and | Open circuit | |
|---|---|---|---|---|---|---|---|---|---|
| | Configuration | Presence | | | charge and | retention | discharge | voltage after | |
| | of negative | or | Charge | Discharge | discharge | rate at | efficiency at | discharge at | Impedance at |
| | electrode | absence | capacity | capacity | efficiency | 50th cycle | 50th cycle | 50th cycle | 50th cycle |
| | active material | of FEC | (mAh/g) | (mAh/g) | (%) | (%) | (%) | (V) | (Ω, 1 kHz) |
| Example 1 | SiOₓ/Li₃PO₄ | Presence | 2170 | 1540 | 71 | 98 | 99.97 | 0.8 | 3 |
| Example 2 | Si/Li₃PO₄ | Presence | 3420 | 2950 | 86 | 83 | 99.5 | 0.55 | 15 |
| Example 3 | SiOₓ/Li₃PO₄ | Absence | 2150 | 1520 | 71 | 85 | 99.85 | 0.65 | 8 |
| Comparative | SiOₓ | Presence | 2360 | 1770 | 75 | 91 | 99.82 | 0.55 | 10 |
| Example 1 | | | | | | | | | |
| Comparative | Si | Presence | 3450 | 2990 | 87 | 73 | 99.2 | 0.5 | 22 |
| Example 2 | | | | | | | | | |
| Comparative | SiOₓ/C | Presence | 2330 | 1720 | 74 | 91 | 99.86 | 0.55 | 9 |
| Example 3 | | | | | | | | | |
| Comparative | Heat treated SiOₓ | Presence | 2140 | 1580 | 74 | 94 | 99.6 | 0.7 | 6 |
| Example 4 | | | | | | | | | |
| Comparative | Heat treated SiO/C | Presence | 2135 | 1540 | 72 | 94 | 99.7 | 0.65 | 6 |
| Example 5 | | | | | | | | | |
| Comparative | SiOₓ | Absence | 2210 | 1640 | 74 | 69 | 99.7 | 0.5 | 18 |
| Example 6 | | | | | | | | | |

From Table 1, the following can be seen.

The cycle characteristics of Example 1 (Li₃PO₄-covered SiOₓ particles, containing FEC) are improved as compared to the cycle characteristics of Comparative Examples 1 (non-covered SiOₓ particles, containing FEC), 3 (carbon-covered SiOₓ particles, containing FEC), 4 (heat-treated non-covered SiOₓ particles, containing FEC), and 5 (heat-treated carbon-covered SiOₓ particles, containing FEC). Specifically, the capacity retention rate and charge and discharge efficiency at the 50th cycle are improved, the open circuit voltage after discharge is increased, and the impedance is decreased.

In the same manner, the cycle characteristics of Example 2 (Li₃PO₄-covered Si particles, containing FEC) are improved as compared to the cycle characteristics of Comparative Example 2 (non-covered Si particles, containing FEC).

The improvement in capacity retention rate and charge and discharge efficiency means that the Li loss during the cycle is significantly small. It is considered that the factor of the improvement in capacity retention rate and charge and discharge efficiency as described above is the suppression of electrolyte decomposition (Li consumption) on the surfaces of the SiOₓ particles and the Si particles.

The high open circuit voltage after discharge means that the ability to withdraw Li from SiOₓ particles and Si particles is high. In other words, it suggests that highly efficient Li de-insertion is possible.

Low impedance means the growth inhibition of electrolyte deposits (SEI). It is considered that such growth inhibition of electrolyte deposits is the covering effect of Li₃PO₄.

The cycle characteristics of Example 3 (Li₃PO₄-covered SiOₓ particles, not containing FEC) are more favorable in both the capacity retention rate and the impedance despite the absence of FEC as compared to the cycle characteristics of Comparative Example 6 (non-covered SiOₓ particles, not containing FEC). From these results, it has been demonstrated that the solid electrolyte Li₃PO₄ covering has a SEI deposition suppressing effect, namely, a FEC decreasing effect.

Hereinafter, the evaluation results for non-covered SiOₓ particles (Comparative Examples 1 and 6), carbon-covered SiOₓ particles (Comparative Example 3), heat-treated non-covered SiOₓ particles (Comparative Example 4), heat-treated carbon-covered SiOₓ particles (Comparative Example 5), and Li₃PO₄-covered SiOₓ particles (Examples 1 and 3) will be described in more detail.

### <Non-Covered SiOₓ Particles>

In a Si-based active material having a low cycle retention rate, SiOₓ has a feature of hardly undergoing bulk collapse even at 100% SOC and exhibits a relatively excellent cycle retention rate. However, as presented in Table 1, the capacity retention rate at the 50th cycle is 69% in Comparative Example 6 (non-covered SiOₓ particles, not containing FEC) and the capacity retention rate at the 50th cycle is 91% in Comparative Example 1 (non-covered SiOₓ particles, containing FEC) as well. Particularly in Comparative Example 6 not containing FEC, a rapid increase in impedance (1 kHz) was observed every cycle. It is considered that this is because SEI deposition on the surface of the active material occurs every cycle. On the other hand, in the case of Comparative Example 1 containing FEC, an increase in 1 kHz impedance is suppressed and the cycle retention rate is also ameliorated. This is because the FEC-derived LiF and C—P—O—F composite coating film are stably formed and excessive electrolyte decomposition is suppressed. However, rapid deterioration due to FEC depletion cannot be avoided since this FEC-derived coating film itself also repeats decomposition and generation (including peeling off due to expansion and contraction) while consuming FEC.

In Comparative Example 6 not containing FEC, an increase in arc (interface resistance) of the Cole-Cole plot has been confirmed. Moreover, it has also been confirmed from the Bode diagram that the presence or absence of FEC only affects the interface resistance.

### <Carbon-Covered SiOₓ Particles>

In Comparative Example 3 (carbon-covered SiOₓ particles, containing FEC), rapid deterioration (capacity retention rate, interface resistance) is suppressed to some extent but an effect to cope with the long-term cycle is not observed. Carbon covering is common as covering of Si active material, but it seems that a question mark is attached to the SEI deposition suppressing effect. In addition, a low (99.86%) charge and discharge efficiency at the 50th cycle also suggests that SEI formation is not suppressed. This is because the carbon covering itself is used for the purpose of eliminating the insufficient conductivity of Si more than the interface protection. However, it is considered that carbon is generally a substance having poor adhesive property to Si and SiOₓ and peeling off of carbon due to expansion and contraction of SiOₓ occurs from the viewpoint of interface protection.

<Heat-Treated Non-Covered SiOₓ Particles and Heat-Treated Carbon-Covered SiOₓ Particles>

In Comparative Example 4 (heat-treated non-covered SiOₓ particles, containing FEC) and Comparative Example 5 (heat-treated carbon-covered SiOₓ particles, containing FEC) as well, rapid deterioration (capacity retention, interface resistance) can be suppressed to some extent but an effect to cope with the long-term cycle is not observed in the same manner as in Comparative Example 3.

<Li₃PO₄-Covered SiOₓ Particles>

In Example 1 (Li₃PO₄-covered SiOₓ particles), rapid deterioration is not observed and the capacity retention rate at the 50th cycle is 98% to be extremely excellent. A rapid increase in impedance is also not observed and the charge and discharge efficiency at the 50th cycle is also 99.97% to exhibit extremely excellent characteristics. The same results has also been observed from the Cole-Cole plot, and it has been confirmed that an arc increase is hardly observed in the Li₃PO₄-covered SiOₓ particles even after 50 cycles.

The cycle characteristics of Example 3 (Li₃PO₄-covered SiOₓ particles, not containing FEC) more favorably undergo a transition in both the capacity retention rate and the impedance despite the absence of FEC as compared those of Comparative Example 6 (non-covered SiOₓ particles, not containing FEC), and it has been demonstrated that the solid electrolyte Li₃PO₄ covering has a SEI deposition suppressing effect, namely, a FEC decreasing effect. However, when the evaluation results for Example 3 (Li₃PO₄-covered SiOₓ particles, not containing FEC) and Example 1 (Li₃PO₄-covered SiOₓ particles, containing FEC) are compared to each other, a tendency has been observed that the cycle characteristics of Example 3 are inferior to the cycle characteristics of Example 1. It can be seen that it is preferable to combine Li₃PO₄ covering with FEC from the viewpoint of improvement in cycle characteristics in consideration of this point.

### <4 Application Example 1>

### “Battery Pack and Electronic Device as Application Example”

In Application Example 1, a battery pack and an electronic device which include the battery according to an embodiment or a modification thereof will be described.

### [Configuration of Battery Pack and Electronic Device]

Hereinafter, a configuration example of a battery pack 300 and an electronic device 400 as an application example will be described with reference to FIG. 10. The electronic device 400 includes an electronic circuit 401 of the electronic device main body and the battery pack 300. The battery pack 300 is electrically connected to the electronic circuit 401 via a positive electrode terminal 331a and a negative electrode terminal 331b. The electronic device 400 has, for example, a configuration in which the battery pack 300 can be attached and detached by the user. Incidentally, the configuration of the electronic device 400 is not limited to this, but the electronic device 400 may have a configuration in which the battery pack 300 is incorporated in the electronic device 400 so that the battery pack 300 cannot be detached from the electronic device 400 by the user.

At the time of charge of the battery pack 300, the positive electrode terminal 331a and negative electrode terminal 331b of the battery pack 300 are connected to the positive electrode terminal and negative electrode terminal of a battery charger (not illustrated), respectively. On the other hand, at the time of discharge of the battery pack 300 (at the time of use of the electronic device 400), the positive electrode terminal 331a and negative electrode terminal 331b of the battery pack 300 are connected to the positive electrode terminal and negative electrode terminal of the electronic circuit 401, respectively.

Examples of the electronic device 400 include laptop personal computers, tablet computers, mobile phones (for example, smart phone), personal digital assistants (PDA), display devices (LCD, EL display, electronic paper and the like), imaging devices (for example, digital still camera and digital video camera), audio devices (for example, portable audio player), game devices, cordless phone handsets, e-books, electronic dictionaries, radios, headphones, navigation systems, memory cards, pacemakers, hearing aids, power tools, electric shavers, refrigerators, air conditioners, televisions, stereos, water heaters, microwaves, dishwashers, washing machines, dryers, lighting devices, toys, medical devices, robots, road conditioners, and traffic lights but are not limited to these.

### (Electronic Circuit)

The electronic circuit 401 includes, for example, a CPU, a peripheral logic unit, an interface unit, and a storage unit and controls the entire electronic device 400.

### (Battery Pack)

The battery pack 300 includes an assembled battery 301 and a charge and discharge circuit 302. The assembled battery 301 is configured by connecting a plurality of secondary batteries 301a in series and or in parallel. The plurality of secondary batteries 301a are connected, for example, n in parallel and m in series (n and m are positive integers). Incidentally, FIG. 10 illustrates an example in which six secondary batteries 301a are connected two in parallel and three in series (2P3S). As the secondary battery 301a, a battery according to an embodiment or a modification thereof is used.

Here, a case in which the battery pack 300 includes the assembled battery 301 configured of the plurality of secondary batteries 301a will be described, but a configuration in which the battery pack 300 includes one secondary battery 301a instead of the assembled battery 301 may be adopted.

The charge and discharge circuit 302 is a control unit which controls charge and discharge of the assembled battery 301. Specifically, at the time of charge, the charge and discharge circuit 302 controls charge with respect to the assembled battery 301. Meanwhile, at the time of discharge (namely, at the time of use of the electronic device 400), the charge and discharge circuit 302 controls discharge with respect to the electronic device 400.

### <5 Application Example 2>

### “Power Storage System in Vehicle as Application Example”

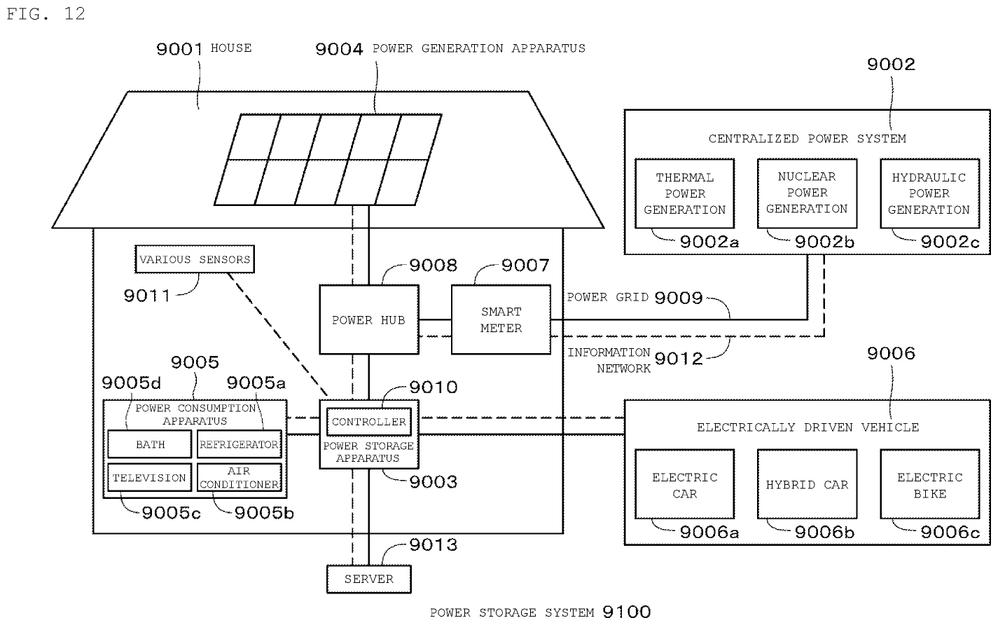

An example in which the present disclosure is applied to a power storage system for vehicle will be described with reference to FIG. 11. FIG. 11 schematically illustrates an example of the configuration of a hybrid vehicle which adopts a series hybrid system to which the present disclosure is applied. The series hybrid system is a vehicle which travels by a power to driving force converter using power generated by a power generator driven by an engine or power once stored in a battery.

On this hybrid vehicle 7200, an engine 7201, a power generator 7202, a power to driving force converter 7203, a driving wheel 7204a, a driving wheel 7204b, a wheel 7205a, and a wheel 7205b, a battery 7208, a vehicle control apparatus 7209, various sensors 7210, and a charging port 7211 are mounted. The power storage apparatus of the present disclosure described above is applied to the battery 7208.

The hybrid vehicle 7200 travels using the power to driving force converter 7203 as a power source. An example of the power to driving force converter 7203 is a motor. The power to driving force converter 7203 is operated by the power of the battery 7208, and the rotational force of this power to driving force converter 7203 is transmitted to the driving wheels 7204a and 7204b. Incidentally, the power to driving force converter 7203 can be applied to both an alternating current motor or a direct current motor by using direct current to alternating current (DC-AC) or invert conversion (AC to DC conversion) at necessary places. The various sensors 7210 control the engine speed via the vehicle control apparatus 7209 and control the opening degree (throttle opening degree) of a throttle valve (not illustrated). The various sensors 7210 include a speed sensor, an acceleration sensor, an engine speed sensor and the like.

The turning force of the engine 7201 is transmitted to the power generator 7202, and the power generated by the power generator 7202 by this turning force can be stored in the battery 7208.

When the hybrid vehicle is decelerated by a brake mechanism (not illustrated), the resistance force at the time of deceleration is applied to power to driving force converter 7203 as a turning force, and the regenerative power generated by the power to driving force converter 7203 by this turning force is stored in the battery 7208.

The battery 7208 can also receive power supply from the external power source using the charging port 211 as an input port and store the received power as the battery 7208 is connected to an external power source of the hybrid vehicle.

Although it is not illustrated, an information processing apparatus which performs information processing on the vehicle control based on the information on the secondary battery may be provided. As such an information processing apparatus, there is, for example, an information processing apparatus which displays the battery residual quantity based on the information on the residual quantity of battery.

Incidentally, in the above, a series hybrid vehicle which travels by a motor using the power generated by a power generator driven by an engine or power once stored in a battery has been described as an example. However, the present disclosure can also be effectively applied to parallel hybrid vehicles in which the outputs of the engine and motor are both used as the driving source and the three methods of traveling only by the engine, traveling only by the motor, and traveling by the engine and motor are appropriately switched and used. Furthermore, the present disclosure can be effectively applied to a so-called electrically driven vehicle which travels by driving only of a drive motor without using an engine.

An example of the hybrid vehicle 7200 to which the art according to the present disclosure can be applied has been described above. The art according to the present disclosure can be suitably applied to the battery 7208 among the configurations described above.

### <6 Application Example 3>

### “Power Storage System in House as Application Example”

An example in which the present disclosure is applied to a power storage system for house will be described with reference to FIG. 12. For example, in a power storage system 9100 for a house 9001, power is supplied from a centralized power system 9002 such as thermal power generation 9002a, nuclear power generation 9002b, or hydraulic power generation 9002c to a power storage apparatus 9003 via a power grid 9009, an information network 9012, a smart meter 9007, a power hub 9008 and the like. Together with this, power is supplied from an independent power source such as a home power generation apparatus 9004 to the power storage apparatus 9003. The power supplied to the power storage apparatus 9003 is stored. The power storage apparatus 9003 is used to supply power to be used in the house 9001. The same power storage system can be used not only for the house 9001 but also for a building.

The house 9001 is provided with a power generation apparatus 9004, a power consumption apparatus 9005, the power storage apparatus 9003, a controller 9010 which controls the respective apparatuses, the smart meter 9007, and a sensor 9011 which acquires various kinds of information. The respective apparatuses are connected to one another by the power grid 9009 and the information network 9012. A solar cell, a fuel cell, and the like are utilized as the power generation apparatus 9004, and the generated power is supplied to the power consumption apparatus 9005 and/or the power storage apparatus 9003. The power consumption apparatus 9005 is a refrigerator 9005a, an air conditioner 9005b, a television receiver 9005c, a bath 9005d and the like. Furthermore, the power consumption apparatus 9005 includes an electrically driven vehicle 9006. The electrically driven vehicle 9006 is an electric car 9006a, a hybrid car 9006b, and an electric bike 9006c.

The battery unit of the present disclosure described above is applied to the power storage apparatus 9003. The power storage apparatus 9003 is configured of a secondary battery or a capacitor. For example, The power storage apparatus 9003 is configured of a lithium ion battery. The lithium ion battery may be a stationary type or one to be used in the electrically driven vehicle 9006. The smart meter 9007 has a function of measuring the quantity of commercial power consumed and transmitting the measured quantity of commercial power consumed to the power company. The power grid 9009 may be any one of direct current feed, alternating current feed, or non-contact feed or combination of a plurality of these.

The various sensors 9011 are, for example, a human sensor, an illuminance sensor, an object detection sensor, a power consumption sensor, a vibration sensor, a contact sensor, a temperature sensor, and an infrared sensor. The information acquired by the various sensors 9011 is transmitted to the controller 9010. By the information from the sensor 9011, the state of the weather, the state of a person and the like are grasped, the power consumption apparatus 9005 can be automatically controlled, and thus the energy consumption can be minimized. Furthermore, the controller 9010 can transmit the information on the house 9001 to the external power company and the like via the Internet.

The power hub 9008 performs processing such as branching of power lines and DC-AC conversion. As a communication method of the information network 9012 connected to the controller 9010, there are a method in which a communication interface such as UART (Universal Asynchronous Receiver-Transmitter) and a method in which a sensor network according to a wireless communication standard such as Bluetooth (registered trademark), ZigBee, and Wi-Fi is utilized. The Bluetooth system is applied to multimedia communication and can perform one-to-many communication. ZigBee uses a physical layer of IEEE (Institute of Electrical and Electronics Engineers) 802.15.4. IEEE 802.15.4 is a name of a short distance wireless network standard called PAN (Personal Area Network) or W (Wireless) PAN.

The controller 9010 is connected to an external server 9013. This server 9013 may be managed by any one of the house 9001, a power company, or a service provider. The information transmitted and received by the server 9013 is, for example, power consumption information, life pattern information, power rates, weather information, natural disaster information, and information on power transactions. These pieces of information may be transmitted and received from a home power consumption apparatus (for example, television receiver) but may be transmitted and received from an apparatus (for example, mobile phone) other than the house. These pieces of information may be displayed on devices having a display function, for example, a television receiver, a mobile phone, and Personal Digital Assistants (PDA).

The controller 9010 which controls the respective units is configured of a Central Processing Unit (CPU), Random Access Memory (RAM), Read Only Memory (ROM) and the like and is housed in the power storage apparatus 9003 in this example. The controller 9010 is connected to the power storage apparatus 9003, the home power generation apparatus 9004, the power consumption apparatus 9005, the various sensors 9011, the server 9013, and the information network 9012 and has, for example, a function of adjusting the quantity of commercial power consumed and the quantity of power generated. Incidentally, the controller 9010 may have a function of performing power transactions in the power market in addition to this.

As described above, power can be stored in the centralized power system 9002 such as the thermal power 9002a, the nuclear power 9002b, or the hydraulic power 9002c, in addition, the power generated by the home power generation apparatus 9004 (solar power generation, wind power generation) can be stored in the power storage apparatus 9003. Hence, control that the quantity of power to be transmitted to the outside is constantly maintained or discharge is performed if necessary can be performed even when the power generated by the home power generation apparatus 9004 fluctuates. For example, a method of use in which the midnight power with a low rate is stored in the power storage apparatus 9003 at night as well as the power obtained by solar power generation is stored in the power storage apparatus 9003, and the power stored in the power storage apparatus 9003 is discharged and consumed in a time zone in which the rate is high in the daytime.

Incidentally, an example in which the controller 9010 is housed in the power storage apparatus 9003 has been described in this example, but the controller 9010 may be housed in the smart meter 9007 or may be configured singly. Furthermore, the power storage system 9100 may be used for a plurality of houses in multiple dwelling or may be used for a plurality of detached houses.

An example of the power storage system 9100 to which the art according to the present disclosure can be applied has been described above. The art according to the present disclosure can be suitably applied to a secondary battery included in the power storage apparatus 9003 among the configurations described above.

Embodiments, modifications thereof, and Examples of the present art have been specifically described above, but the present art is not limited to the embodiments, modifications thereof, and Examples, and various modifications based on the technical ideas of the present art are possible.

For example, the configurations, methods, steps, shapes, materials, numerical values, and the like mentioned in the above-described embodiments, modifications thereof, and Examples are merely examples, and other configurations, methods, steps, shapes, materials, numerical values, and the like may be used if necessary. In addition, chemical formulas of compounds and the like are representative ones and are not limited to the indicated valences and the like as long as the names are the common names of the same compounds.

In addition, the configurations, methods, steps, shapes, materials, numerical values, and the like of the above-described embodiments, modifications thereof, and Examples can be combined with one another without departing from the spirit of the present art.

Moreover, an example in which the present art is applied to cylindrical and laminated film type secondary batteries has been described in the above-described embodiments and Examples, but the shape of battery is not particularly limited. For example, the present art can also be applied to a secondary battery such as a square type and a coin type, and the present art can also be applied to a smart watch, a head mounted display, a flexible battery mounted on a wearable terminal such as iGlass (registered trademark), and the like.

Moreover, an example in which the present art is applied to a wound battery has been described in the above-described embodiments and Examples, but the structure of battery is not particularly limited, and for example, the present art can also be applied to a secondary battery having a structure (stacked electrode structure) in which a positive electrode and a negative electrode are stacked, and a secondary battery having a structure in which a positive electrode and a negative electrode are folded.

Moreover, a configuration in which the electrodes (positive electrode and negative electrode) include a collector and an active material layer has been described as an example in the above-described embodiments and Examples, but the structure of electrode is not particularly limited. For example, a configuration in which the electrode is configured only of an active material layer may be adopted.

In addition, the positive electrode active material layer may be a green compact containing a positive electrode material or may be a sintered body of a green sheet containing a positive electrode material. The negative electrode active material layer may also be a green compact or a sintered body of a green sheet in the same manner.

Moreover, an example in which the present art is applied to a lithium ion secondary battery and a lithium ion polymer secondary battery has been described in the above-described embodiments and Examples, but the kind of battery to which the present art can be applied is not limited to this. For example, the present art may be applied to bulk-type all-solid-state batteries and the like. In addition, the present art may be applied to a lithium-sulfur battery in which silicon is contained in the negative electrode.

In addition, the present art can also adopt the following configurations.

(1)

A negative electrode active material having:

a core portion containing at least one of silicon, tin, or germanium; and

a covering portion covering at least a part of a surface of the core portion, in which

the covering portion contains a phosphoric acid-containing compound.

(2)

The negative electrode active material according to (1), in which the core portion contains at least one of crystalline silicon, amorphous silicon, silicon oxide, a silicon alloy, crystalline tin, amorphous tin, tin oxide, a tin alloy, crystalline germanium, amorphous germanium, germanium oxide, or a germanium alloy.

(3)

The negative electrode active material according to (1) or (2), in which the phosphoric acid-containing compound is represented by the following Formula (1).

M_{z}PₓO_{y}:XX (1)

(Provided that M represents at least one of metal elements and XX represents at least one of a group 15 element, a group 16 element, or a group 17 element. z is 0.1≤z≤3, x is 0.5≤x≤2, and y is 1≤y≤5.)
(4)

The negative electrode active material according to (3), in which

M is at least one of Li, Mg, Al, B, Na, K, Ca, Mn, Fe, Co, Ni, Cu, Ag, Zn, Ga, In, Pb, Mo, W, Zr, or Hf, and

XX is at least one of N, F, S, Cl, As, Se, Br, or I.

(5)

The negative electrode active material according to (3), in which

M is at least one of Mg, Al, B, Na, K, Ca, Mn, Fe, Co, Ni, Cu, Ag, Zn, Ga, In, Pb, Mo, W, Zr, or Hf, and

XX is at least one of N, F, S, Cl, As, Se, Br, or I.

(6)

The negative electrode active material according to any one of (1) to (5), in which the covering portion further contains at least one of carbon, a hydroxide, an oxide, a carbide, a nitride, a fluoride, a hydrocarbon molecule, or a polymer compound.

(7)

The negative electrode active material according to any one of (1) to (5), having at least one of a first covering portion that is provided between the core portion and the covering portion and covers at least a part of a surface of the core portion or a second covering portion covering at least a part of a surface of the covering portion, in which

the first covering portion and the second covering portion contain at least one of carbon, a hydroxide, an oxide, a carbide, a nitride, a fluoride, a hydrocarbon molecule, or a polymer compound.

(8)

The negative electrode active material according to (6) or (6), in which a content of the at least one is 0.05 mass % or more and 10 mass % or less.

(9)

The negative electrode active material according to any one of (1) to (8), in which the core portion has a particulate shape, a layered shape, or a three-dimensional shape.

(10)

The negative electrode active material according to any one of (1) to (8), in which the core portion is a thin film.

(11)

The negative electrode active material according to any one of (1) to (10), in which the covering portion covers the core portion as a whole.

(12)

A negative electrode containing the negative electrode active material according to any one of (1) to (11).

(13)

A battery including:

a negative electrode containing the negative electrode active material according to any one of (1) to (11);

a positive electrode; and

an electrolyte.

(14)

The battery according to (13), in which the electrolyte contains an electrolytic solution.

(15)

The battery according to (14), in which the electrolytic solution contains fluoroethylene carbonate.

(16)

A battery pack including:

the battery according to any one of (13) to (15); and a control unit configured to control the battery.

(17)

An electronic device including the battery according to any one of (13) to (15), in which

the electronic device receives power supply from the battery.

(18)

An electrically driven vehicle including:

the battery according to any one of (13) to (15);

a converter configured to receive power supply from the battery and convert the power into a driving force of the vehicle; and

a controller configured to perform information processing on vehicle control based on information on the battery.

(19)

A power storage apparatus including the battery according to any one of (13) to (15), in which

the power storage apparatus supplies power to an electronic device connected to the battery.

(20)

A power system including the battery according to any one of (13) to (15), in which

the power system receives power supply from the battery.

### DESCRIPTION OF REFERENCE SYMBOLS

1: Core portion
2: Covering portion
3: First covering portion
4: Second covering portion
11: Battery can
12, 13: Insulating plate
14: Battery lid
15: Safety valve mechanism
15A: Disc plate
16: Positive temperature coefficient element
17: Gasket
20: Wound electrode assembly
21: Positive electrode
21A: Positive electrode current collector
21B: Positive electrode active material layer
22: Negative electrode
22A: Negative electrode current collector
22B: Negative electrode active material layer
23: Separator
24: Center pin
25: Positive electrode lead
26: Negative electrode lead

1. A negative electrode active material comprising:
a core portion containing at least one of silicon, tin, or germanium; and
a covering portion covering at least a part of a surface of the core portion, wherein
the covering portion contains a phosphoric acid-containing compound.

2. The negative electrode active material according to claim 1, wherein the core portion contains at least one of crystalline silicon, amorphous silicon, silicon oxide, a silicon alloy, crystalline tin, amorphous tin, tin oxide, a tin alloy, crystalline germanium, amorphous germanium, germanium oxide, or a germanium alloy.

3. The negative electrode active material according to claim 1, wherein the phosphoric acid-containing compound is represented by the following Formula (1).
M_{z}PₓO_{y}:XX (1)
(Provided that M represents at least one of metal elements and XX represents at least one of a group 15 element, a group 16 element, or a group 17 element. z is 0.1≤z≤3, x is 0.5≤x≤2, and y is 1≤y≤5.)

4. The negative electrode active material according to claim 3, wherein
M is at least one of Li, Mg, Al, B, Na, K, Ca, Mn, Fe, Co, Ni, Cu, Ag, Zn, Ga, In, Pb, Mo, W, Zr, or Hf, and
XX is at least one of N, F, S, Cl, As, Se, Br, or I.

5. The negative electrode active material according to claim 3, wherein
M is at least one of Mg, Al, B, Na, K, Ca, Mn, Fe, Co, Ni, Cu, Ag, Zn, Ga, In, Pb, Mo, W, Zr, or Hf, and
XX is at least one of N, F, S, Cl, As, Se, Br, or I.

6. The negative electrode active material according to claim 1, wherein the covering portion further contains at least one of carbon, a hydroxide, an oxide, a carbide, a nitride, a fluoride, a hydrocarbon molecule, or a polymer compound.

7. The negative electrode active material according to claim 1, comprising at least one of a first covering portion that is provided between the core portion and the covering portion and covers at least a part of a surface of the core portion or a second covering portion covering at least a part of a surface of the covering portion, wherein the first covering portion and the second covering portion contain at least one of carbon, a hydroxide, an oxide, a carbide, a nitride, a fluoride, a hydrocarbon molecule, or a polymer compound.

8. The negative electrode active material according to claim 6, wherein a content of the at least one is 0.05 mass % or more and 10 mass % or less.

9. The negative electrode active material according to claim 1, the core portion has a particulate shape, a layered shape, or a three-dimensional shape.

10. The negative electrode active material according to claim 1, wherein the core portion is a thin film.

11. The negative electrode active material according to claim 1, wherein the covering portion covers the core portion as a whole.

12. A negative electrode comprising the negative electrode active material according to claim 1.

13. A battery comprising:
a negative electrode containing the negative electrode active material according to claim 1;
a positive electrode; and
an electrolyte.

14. The battery according to claim 13, wherein the electrolyte contains an electrolytic solution.

15. The battery according to claim 14, wherein the electrolytic solution contains fluoroethylene carbonate.

16. A battery pack comprising:
the battery according to claim 13; and
a control unit configured to control the battery.

17. An electronic device comprising the battery according to claim 13, wherein
the electronic device receives power supply from the battery.

18. An electrically driven vehicle comprising:
the battery according to claim 13;
a converter configured to receive power supply from the battery and convert the power into a driving force of the vehicle; and
a controller configured to perform information processing on vehicle control based on information on the battery.

19. A power storage apparatus comprising the battery according to claim 13, wherein
the power storage apparatus supplies power to an electronic device connected to the battery.

20. A power system comprising the battery according to claim 13, wherein
the power system receives power supply from the battery.
